(19) United States
(12) Patent Application Publication
(10) Pub. No.: US 2016/0084230 A1
(43) Pub. Date: Mar. 24, 2016

(54) Apparatus and Method to Utilize Wind Power to Generate Electricity

(71) Applicants: Byron B. Carson, JR., Memphis, TN (US); Grey L. Neely, Clarksdale, MS (US); Robert W. Hawks, Memphis, TN (US); Robert B. Felty, Virginia Beach, VA (US)

(72) Inventors: Byron B. Carson, JR., Memphis, TN (US); Grey L. Neely, Clarksdale, MS (US); Robert W. Hawks, Memphis, TN (US); Robert B. Felty, Virginia Beach, VA (US)

(21) Appl. No.: 14/956,746

(22) Filed: Dec. 2, 2015

Related U.S. Application Data
(63) Continuation of application No. 13/549,277, filed on Jul. 13, 2012.
(60) Provisional application No. 61/507,527, filed on Jul. 13, 2011.

(51) Int. Cl. F03D 9/00; F03D 1/02; H02K 15/14; F03D 11/04

(52) U.S. Cl. CPC F03D 9/005; F03D 11/04; F03D 1/02; H02K 15/14

(57) ABSTRACT

An apparatus that utilizes wind power to generate electricity is disclosed. In one embodiment, the apparatus comprises a plurality of horizontal axis wind turbine systems mounted onto a structure having framing. The plurality of horizontal axis wind turbine systems are securely mounted to the framing of the structure with a mounting system. Each horizontal axis wind turbine system is connected to a cable which is connected to a utility substation for distribution and supplies newly created electrical energy to a local electrical grid system. A method that utilizes wind power to generate electricity is also disclosed.

### PRIORITY CLAIMED

Pursuant to 35 U.S.C. 120, this application claims priority to U.S. patent application Ser. No. 13/549,277, filed on Jul. 13, 2012, which claims priority to U.S. Patent Application No. 61/507,527, filed on Jul. 13, 2011. U.S. patent application Ser. Nos. 13/549,277 and 61/507,527 are incorporated by reference herein.

### FIELD

The present disclosure relates generally to an apparatus and method that utilizes wind power to generate electricity. More specifically, the present disclosure relates to an apparatus and method that utilizes wind power to create clean energy comprising a plurality of horizontal axis wind turbine systems mounted onto an existing or new structure.

### BACKGROUND

Wind energy is rapidly becoming one of the most cost-effective forms of renewable energy. Recent investments have been made by entities such as large utility companies in large horizontal axis wind turbines to create wind energy. Such wind turbines have blades that rotate around a horizontal axis. Large horizontal axis wind turbines are typically located in wind farms on wide open prairie fields or other vast amounts of land dedicated to their use. Entities have chosen to invest in large horizontal wind turbines because of their large capacity of electrical energy production from a single source of installation and investment.

Small horizontal axis wind turbines are available for use but are designed for residential and small commercial markets. Small horizontal axis wind turbines are not generally available for use by the industrial utility markets, which are governed by large utility authorities, metropolitan utility companies, Rural Electrification Act Membership Cooperatives (REAs) and small town utility district companies, as a supplemental source for new electrical energy production.

There is a need to create or generate electricity by incorporating and mounting small horizontal axis wind turbine systems onto new and existing structures for use by various entities such as industrial utility companies, city or state departments of transportation, commercial and governmental telecommunication industry, city and county school districts, and the commercial advertising industry, ground military installations, and numerous other businesses. By incorporating a plurality of small wind turbines systems onto existing or new structures, the various entities will achieve their maximum production of new electricity. This apparatus and method will reduce energy costs and reduce the carbon footprint by depending less on coal fired utility plants.

### BRIEF SUMMARY

An apparatus and method that utilize wind power to generate electricity is disclosed. In one example embodiment, the apparatus comprises a plurality of horizontal axis wind turbine systems mounted to any existing or new structure as desired by one of skill in the art. Existing or new structures include, but are not limited to, transmission towers of varying dimensions and specifications such as typical structural transmission towers, twin pole transmission towers and high rise monopole transmission towers.

The number of horizontal axis wind turbines systems mounted on a transmission tower or other new or existing structure may vary depending on the individual dimensions and specifications of each tower or other existing or new structure. The total number of horizontal axis wind turbine systems mounted on transmission tower or other structure will affect the amount of electricity generated. As the number of horizontal axis wind turbine systems mounted on tower increases, the amount of electricity generated increases.

A method that utilizes wind power to generate energy also is disclosed. The method comprises the following steps of mounting a plurality of horizontal axis wind turbine systems to any new or existing structure.

### BRIEF DESCRIPTION OF THE DRAWINGS

The present disclosure will be better understood by reference to the following detailed description when considered in conjunction with the accompanying drawings wherein:

FIG. 1a is a perspective view of an apparatus that utilizes wind power to generate electricity comprising a plurality of horizontal axis wind turbine systems mounted onto a transmission tower according to an example embodiment of the present invention.

FIG. 1b is a perspective side view of the apparatus that utilizes wind power to generate electricity comprising a plurality of horizontal axis wind turbine systems mounted onto a transmission tower of FIG. 1a.

FIG. 1c is a plan view of a first level of the apparatus of FIGS. 1a and 1b at the line 1c-1c.

FIG. 1d is a plan view of a second level of the apparatus of FIGS. 1a and 1b at the line 1d-1d.

FIG. 1e is a plan view of a third level of the apparatus of FIGS. 1a and 1b at the line 1e-1e.

FIG. 2a is a perspective view of an apparatus that utilizes wind power to generate electricity comprising a plurality of horizontal axis wind turbine systems mounted onto a transmission tower according to a second example embodiment of the present invention.

FIG. 2b is a perspective side view of the apparatus that utilizes wind power to generate electricity comprising a plurality of horizontal axis wind turbine systems mounted onto a transmission tower of FIG. 2a.

FIG. 2c is a plan view of a first level of the apparatus of FIGS. 2a and 2b at the line 2c-2c.

FIG. 2d is a plan view of a second level of the apparatus of FIGS. 2a and 2b at the line 2d-2d.

FIG. 2e is a plan view of a third level of the apparatus of FIGS. 2a and 2b at the line 2e-2e.

FIG. 3a is a perspective view of an apparatus that utilizes wind power to generate electricity comprising a plurality of horizontal axis wind turbine systems mounted onto a twin pole transmission tower having two horizontal trusses according to a third example embodiment of the present invention.

FIG. 3b is a perspective side view of the apparatus that utilizes wind power to generate electricity comprising a plurality of horizontal axis wind turbine systems mounted onto a twin pole transmission tower of FIG. 3a.

FIG. 3c is a plan view of a first horizontal truss of the apparatus of FIGS. 3a and 3b at the line 3c-3c.

FIG. 3d is a plan view of a second horizontal truss of the apparatus of FIGS. 3a and 3b at the line 3d-3d.

FIG. 4a is a perspective view of an apparatus that utilizes wind power to generate electricity comprising a plurality of horizontal axis wind turbine systems mounted onto a electronic transmission tower according to a fourth embodiment of the present invention.

FIG. 4b is a perspective side view of the apparatus that utilizes wind power to generate electricity comprising a plurality of horizontal axis wind turbine systems mounted onto a electronic transmission tower of FIG. 4a.

FIG. 4c is a plan view of a first level of the apparatus of FIGS. 4a and 4b at the line 4c-4c.

FIG. 4d is a plan view of a second level of the apparatus of FIGS. 4a and 4b at the line 4d-4d.

FIG. 4e is a plan view of a third level of the apparatus of FIGS. 4a and 4b at the line 4e-4e.

FIG. 5a is a perspective view of an apparatus that utilizes wind power to generate electricity comprising a plurality of horizontal axis wind turbine systems mounted onto a billboard support structure according to another example embodiment of the present invention.

FIG. 5b is a perspective side view of the apparatus that utilizes wind power to generate electricity comprising a plurality of horizontal axis wind turbine systems mounted onto a billboard support structure of FIG. 5a.

FIG. 5c is a plan view of the top of the apparatus of FIGS. 5a and 5b at the line 5c-5c.

FIG. 6a is a perspective view of an apparatus that utilizes wind power to generate electricity comprising a plurality of horizontal axis wind turbine systems mounted onto a billboard support structure according to yet another example embodiment of the present invention.

FIG. 6b is a perspective side view of the apparatus that utilizes wind power to generate electricity comprising a plurality of horizontal axis wind turbine systems mounted onto a billboard support structure of FIG. 6a.

FIG. 6c is a plan view of the top of the apparatus of FIGS. 6a and 6b at the line 6c-6c.

FIG. 7a is a perspective view of an apparatus that utilizes wind power to generate electricity comprising a plurality of horizontal axis wind turbine systems mounted onto a high rise monopole transmission tower according to a further example embodiment of the present invention.

FIG. 7b is a perspective side view of the apparatus that utilizes wind power to generate electricity comprising a plurality of horizontal axis wind turbine systems mounted onto a high rise monopole transmission tower of FIG. 7a.

FIG. 7c is a plan view of a first level of the apparatus of FIGS. 7a and 7b at the line 7c-7c.

FIG. 7d is a plan view of a second level of the apparatus of FIGS. 7a and 7b at the line 7d-7d.

FIG. 8a is a perspective view of an apparatus that utilizes wind power to generate electricity comprising a plurality of horizontal axis wind turbine systems mounted onto a high rise monopole transmission tower according to another example embodiment of the present invention.

FIG. 8b is a perspective side view of the apparatus that utilizes wind power to generate electricity comprising a plurality of horizontal axis wind turbine systems mounted onto a high rise monopole transmission tower of FIG. 8a.

FIG. 8c is a plan view of a first level of the apparatus of FIGS. 8a and 8b at the line 8c-8c.

FIG. 8d is a plan view of a top level of the apparatus of FIGS. 8a and 8b at the line 8d-8d.

FIG. 9a is a perspective view of an apparatus that utilizes wind power to generate electricity comprising at least one horizontal axis wind turbine system mounted onto a support pole of a single electrical highway light fixture according to another example embodiment of the present invention.

FIG. 9b is a perspective side view of the apparatus that utilizes wind power to generate electricity comprising at least one horizontal axis wind turbine system mounted onto a support pole of a single electrical highway light fixture of FIG. 9a.

FIG. 9c is a plan view of the apparatus of FIGS. 9a and 9b at the line 9c-9c.

FIG. 10a is a perspective view of an apparatus that utilizes wind power to generate electricity comprising at least one horizontal axis wind turbine system mounted onto a support pole of a double electrical highway light fixture according to yet another example embodiment of the present invention.

FIG. 10b is a perspective side view of the apparatus that utilizes wind power to generate electricity comprising at least one horizontal axis wind turbine system mounted onto a support pole of a double electrical highway light fixture of FIG. 10a.

FIG. 10c is a plan view of the apparatus of FIGS. 10a and 10b at the line 10c-10c.

FIG. 11a is a perspective view of an apparatus that utilizes wind power to generate electricity comprising a plurality of horizontal axis wind turbine systems mounted onto a support structure of a water tower according to a further example embodiment of the present invention.

FIG. 11b is a perspective side view of the apparatus that utilizes wind power to generate electricity comprising a plurality of horizontal axis wind turbine systems mounted onto a support structure of a water tower of FIG. 11a.

FIG. 11c is a plan view of a typical level of the apparatus of FIGS. 11a and 11b at the line 11c-11c.

FIG. 12a is a perspective view of an apparatus that utilizes wind power to generate electricity comprising a plurality of horizontal axis wind turbine systems mounted onto a transmission tower according to a further example embodiment of the present invention.

FIG. 12b is a perspective side view of the apparatus that utilizes wind power to generate electricity comprising a plurality of horizontal axis wind turbine systems mounted onto a transmission tower of FIG. 12a.

FIG. 12c is a plan view of a first level of the apparatus of FIGS. 12a and 12b at the line 12c-12c.

FIG. 12d is a plan view of a second level of the apparatus of FIGS. 12a and 12b at the line 12d-12d.

FIG. 12e is a plan view of an interior level of the apparatus of FIGS. 12a and 12b at the line 12e-12e.

FIG. 13a is a perspective view of an apparatus that utilizes wind power to generate electricity comprising a plurality of horizontal axis wind turbine systems onto the support structure of a highway directional billboard which aids vehicular traffic according to another example embodiment of the present invention. The directional billboard has a left and right support side each with two support poles. Each side depicts a possible configuration for the incorporation of a plurality of horizontal axis wind turbine systems onto the support structure of a highway directional billboard.

FIG. 13b is a perspective side view of the left support side of the apparatus that utilizes wind power to generate electricity comprising a plurality of horizontal axis wind turbine systems onto the support structure of a highway directional billboard which aids vehicular traffic of FIG. 13a.

FIG. 13c is a perspective side view of the right support side of the apparatus that utilizes wind power to generate electricity comprising a plurality of horizontal axis wind turbine systems onto the support structure of a highway directional billboard which aids vehicular traffic of FIG. 13a.

FIG. 13d is a plan view of the top of the apparatus of FIG. 13a at the line 13d-13d.

FIG. 14a is a perspective view of an apparatus that utilizes wind power to generate electricity comprising a plurality of horizontal axis wind turbine systems mounted onto a transmission tower according to another example embodiment of the present invention.

FIG. 14b is a perspective side view of the apparatus that utilizes wind power to generate electricity comprising a plurality of horizontal axis wind turbine systems onto a transmission tower of FIG. 14a.

FIG. 14c is a plan view of a first level of the apparatus of FIGS. 14a and 14b at the line 14c-14c.

FIG. 14d is a plan view of a second level of the apparatus of FIGS. 14a and 14b at the line 14d-14d.

FIG. 14e is a plan view of a first horizontal truss of FIGS. 14a and 14b at the line 14e-14e.

FIG. 14f is a plan view of the second horizontal truss of FIGS. 14a and 14b at the line 14f-14f.

FIG. 15a is a perspective view of an apparatus that utilizes wind power to generate electricity comprising a plurality of horizontal axis wind turbine systems mounted onto a twin pole transmission tower according to another example embodiment of the present invention.

FIG. 15b is a perspective side view of the apparatus that utilizes wind power to generate electricity comprising a plurality of horizontal axis wind turbine systems mounted onto a twin pole transmission tower of FIG. 15a.

FIG. 15c is a plan view of a level of the apparatus of FIG. 15a at the line 15c-15c.

FIG. 16a is a perspective view of an apparatus that utilizes wind power to generate electricity comprising a plurality of horizontal axis wind turbine systems mounted onto a light standard according to another example embodiment of the present invention.

FIG. 16b is a perspective side view of the apparatus that utilizes wind power to generate electricity comprising a plurality of horizontal axis wind turbine systems mounted onto a light standard of FIG. 16a.

FIG. 16c is a plan view of a level of the apparatus of FIGS. 16 at the line 16c-16c.

FIG. 17a is an enlarged front elevational view of a horizontal axis wind turbine system and mounting system according to an example embodiment of the invention.

FIG. 17b is a perspective side view of the horizontal axis wind turbine system and mounting system of FIG. 17a.

FIG. 17c is a perspective view of the diagonal bracing support and connection support elements of the mounting system of FIG. 17a indicated at 17c of FIG. 17a.

FIG. 17d is a perspective view of a diagonal bracing support and connection support elements of the mounting system of FIG. 17a indicated at 17d on FIG. 17a.

FIG. 17e is a perspective view of the mounting system of FIG. 17a at the line 17e-17e.

FIG. 17f is a plan view of the pole anchor base support of the mounting system of FIG. 17a at the line 17f-17f.

FIG. 17g is a perspective side view of the mounting system of FIG. 17e.

FIG. 17h is a perspective view of the mounting system of FIG. 17a at the diagonal arrow indicated at 17h on FIG. 17a.

### DETAILED DESCRIPTION

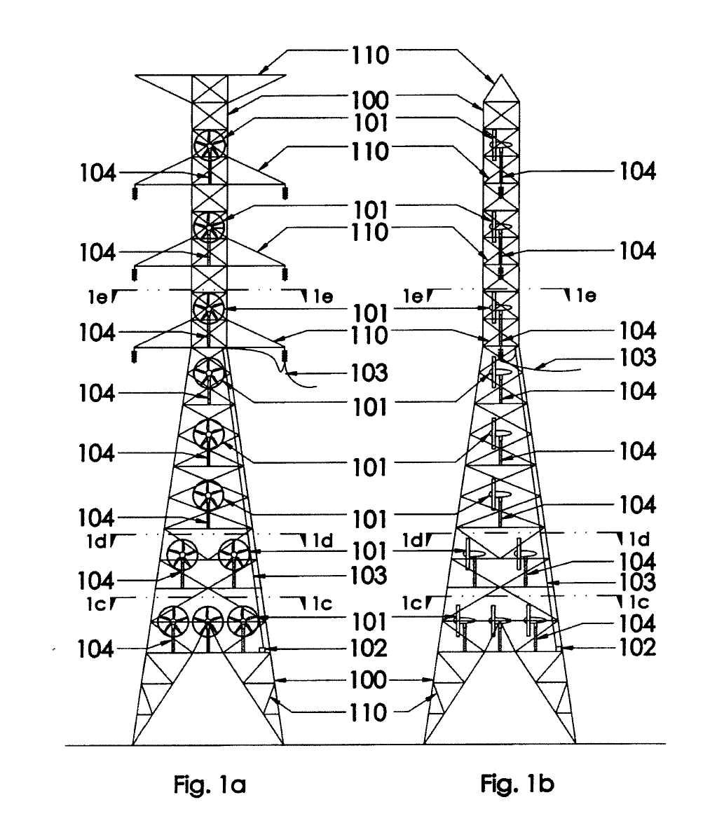

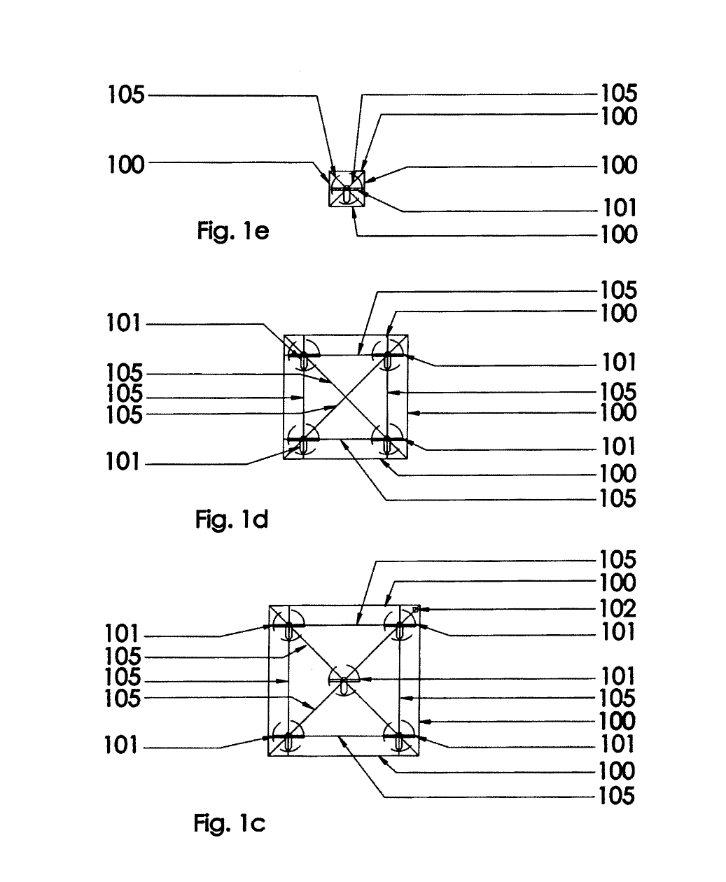

Referring to FIGS. 1a to 17h, an apparatus and method to utilize wind power to generate electricity is disclosed. In one embodiment, the apparatus comprises a plurality of horizontal axis wind turbine systems 101 mounted to any existing or new structure as desired by one of skill in the art. Existing or new structures include, but are not limited to, transmission towers of varying dimensions and specifications such as typical structural transmission towers, twin pole transmission towers and high rise monopole transmission towers. Existing and new structures may also include transmission towers similar to all utility company owned high-rise and other miscellaneous types of electrical transmission towers, such as monopole and twin pole transmission towers; commercial, governmental and military telecommunication towers of all types; city, county, and state operated street and highway electrical light standards; commercial business street and highway billboard structures; city, county, state and military owned and operated utility water towers; and city, county, state, and private academic educational, and major business sports outdoor athletic field light standards.

In one embodiment, existing structures are made of steel, but other materials, such as wood, may be used as desired by one skilled in the art. Existing or new structures may also include, but are not limited to support structures of billboards, support structures of water tanks, and support structures of highway directional billboards which aid in vehicular traffic. Existing or new structures may further include light standards.

Referring now to FIGS. 1a and 1b, an apparatus that utilizes wind power to generate electricity comprising a plurality of horizontal axis wind turbine systems 101 mounted on a transmission tower 100 is disclosed. In one example embodiment, transmission tower 100 is made of steel framing and is approximately one hundred fifty feet in height. In one example embodiment, transmission tower 100 may be constructed with a square structural base with dimensions of approximately thirty-four feet by thirty-four feet. Each corner leg of the square structural base is constructed with vertical galvanized steel angles having dimensions of about five inches by five inches. A steel horizontal cord (with dimensions of about one and one-half inches by one and one-half inches) is connected to each corner leg angle. Steel angles with dimensions of about two inches by one and one-half inches are used throughout transmission tower 100 as diagonal bracing cords or framing 110. Specific dimensions and specifications of each transmission tower 100 may vary as desired by one skilled in the art, depending on the specific purpose and/or desired placement of each transmission tower 100.

In one example embodiment, transmission tower 100 has a plurality of levels on which to mount one or more horizontal axis wind turbine systems 101, including low, middle and high levels with low levels being closest to the ground in relation to the other levels. The level may also be referred to as first, second, third, etc., with the first level being closest to the ground in relation to the other levels. In one example embodiment, a plurality of horizontal axis wind turbines systems 101 may be mounted on low and middle levels of transmission tower 100 while one horizontal axis wind turbines system 101 may be mounted on middle and/or high levels of transmission tower 100 due to the dimensions and specifications of tower 100. The number of horizontal axis wind turbines systems 101 mounted on each level of transmission tower 100 may vary depending on the individual dimensions and specifications of each transmission tower 100. The total number of horizontal axis wind turbine systems 101 mounted on transmission tower 100 will affect the amount of electricity generated. As the number of horizontal axis wind turbine systems 101 mounted on tower 100 increases, the amount of electricity generated increases.

Referring again to FIGS. 1a to 1e, in one example embodiment, fifteen horizontal axis wind turbines systems 101 are mounted on the plurality of levels of transmission tower 100. In another example embodiment, less than fifteen horizontal axis wind turbines systems 101 may be mounted on the plurality of levels of transmission tower 100 if desired. In one example embodiment, five horizontal axis wind turbine systems 101 are mounted on a first or low level of transmission tower 100 (shown in FIG. 1c). In another example embodiment, four horizontal axis wind turbine systems 101 are mounted on a second or middle level of transmission tower 100 (shown in FIG. 1d). In yet another example embodiment, one horizontal axis wind turbine system 101 is mounted onto a third or high level of transmission tower 100 (shown in FIG. 1e). The number and placement of horizontal axis wind turbine systems 101 mounted onto a transmission tower 100 or other existing or new structure may vary as desired by one skilled in the art, taking into consideration the individual dimensions and specifications of such transmission tower 100 or other structure.

In one example embodiment, each horizontal axis wind turbine system 101 weighs approximately two hundred and fifty pounds. The weight of the horizontal axis wind turbine system 101 may vary as desired by one of skill in the art. In another example embodiment, the wind turbine system 101 has a rotor diameter of about seven feet. The rotor diameter of the wind turbine system 101 may vary as desired by one of skill in the art. In yet another example embodiment, wind turbine system 101 has an annual energy production of approximately twelve hundred kilowatts per hour at five meters per second when the annual wind speed average is five meters per second. In one example embodiment, the annual energy production of the horizontal axis wind turbine system 101 may be approximately two thousand kWh at six m/s (13.4 mph annual wind average). In one embodiment, the horizontal axis wind turbine system 101 may have electrical power specification of 240 volts of AC power at 60 hertz output voltage. In one embodiment, the horizontal axis wind turbine system 101 may have a grid connection of G83 Certified, grid-tied system. In one embodiment, the horizontal axis wind turbine system 101 may have a minimum clearance of twenty four inches. The specifications of the horizontal axis wind turbine systems 101 may vary as desired by one of skill in the art.

In one embodiment, the horizontal axis wind turbine system 101 may have a mounting system which may include a thermal break, sound isolator or isolation pads and vertical and/or horizontal pole support. In one embodiment, the thermal break comprises a specified thickness comprised of a phenolic plastic composition or neoprene plastic. Other materials may be used as desired by one of skill in the art. The thermal break maintains a minimum separation between the framing of the structure or tower and the mechanical connection fillings used to mount the horizontal axis wind turbine system 101 to the structure or tower in order to control the surface temperature between two connection materials. The sound isolation pads may be used to control vibrations between the horizontal axis wind turbine system 101 and the structure or tower framing.

In one example embodiment, horizontal axis wind turbines systems 101 are installed at about thirty feet and above on tower 100 or other existing or new structure. At about thirty feet or above ground level, horizontal axis wind turbine systems 101 are quiet and visually un-obtrusive. Horizontal axis wind turbine systems 101 mounted on tower 100 or other new or existing tower are environmentally productive by providing clean, new energy on a twenty-four hour daily basis.

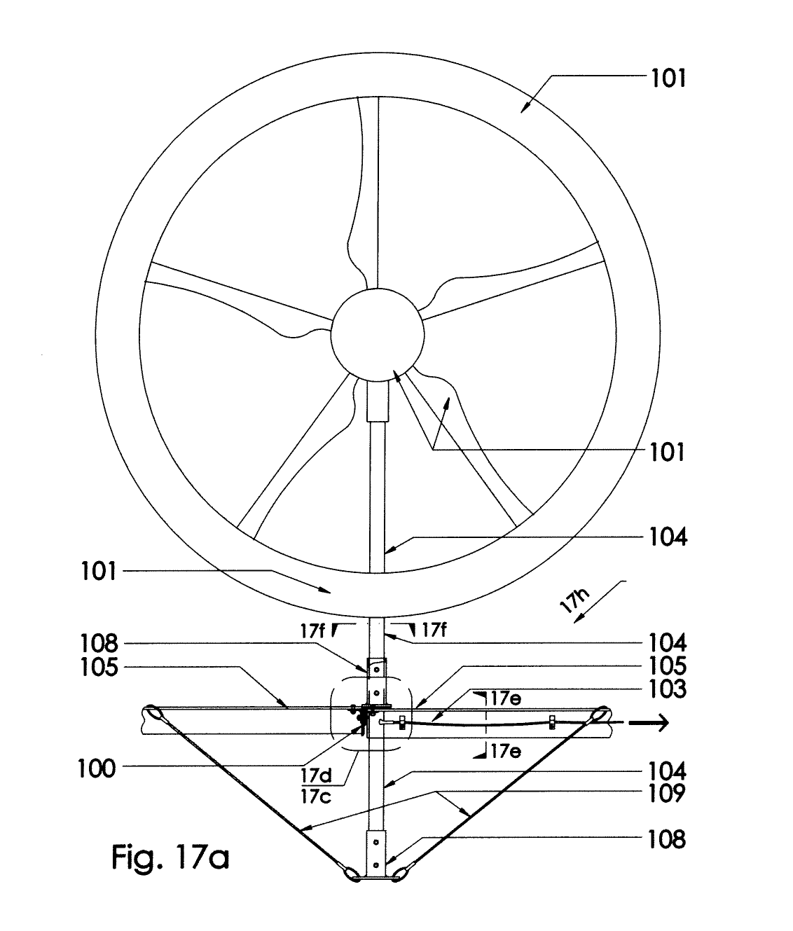

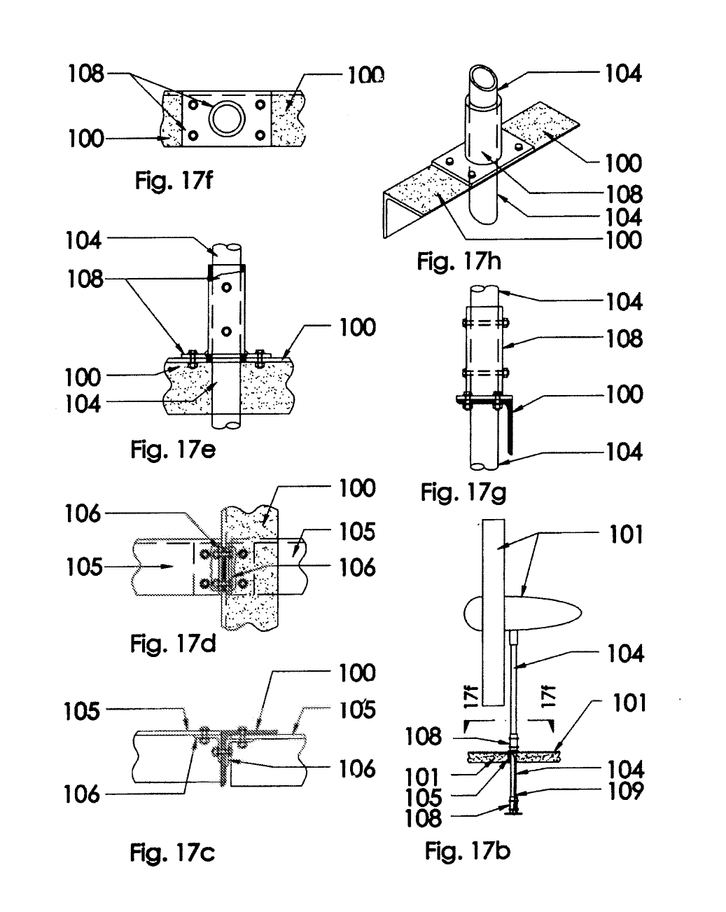

Referring now to FIGS. 1a to 17h, in one example embodiment, horizontal axis wind turbine system 101 may be mounted onto the framing of transmission tower 100 or other structure. Wind turbine systems 101 may be coupled to a vertical or horizontal pole support 104. In one embodiment, pole support 104 is made of steel, but any other material may be used as desired by one skilled in the art. In one example embodiment, pole support 104 is attached to the framing of transmission tower 100 or any other existing or new structure. In one embodiment, pole support 104 may be vertical and may be secured to tower 100 with a first and second pole anchor base supports 108 (see FIG. 17a.). Two three-way bolts may be used to secure pole support 104 to first and second base supports 108. In one embodiment, first and second pole anchor base supports 108 have a base plate with four apertures at each corner of the plate (see FIG. 17f.). First anchor base support 108 is mounted onto the framing of transmission tower 100 by securing the base plate of support 108 to tower 100 with four bolts through apertures. In one embodiment, diagonal bracing support 105 (see FIG. 17a) may be used to support and secure the framing of tower 100 and the pole support 104. Connection support elements 106 (see FIGS. 17c and 17d) further support diagonal bracing support 105. Referring to FIG. 17a, in one embodiment, coaxial steel cables 109 are used for diagonal torque support of the second base support 108 to diagonal bracing support 105. In one example embodiment, four coaxial cables 109 may be used for diagonal torque support. In another example embodiment, instead of the coaxial cables, a galvanized steel support pole may be used for a second contact control point at second base support 108. In one embodiment, the second base support is necessary in order to control the horizontal loading torque of the wind that is displaced upon the mass of turbine system 101.

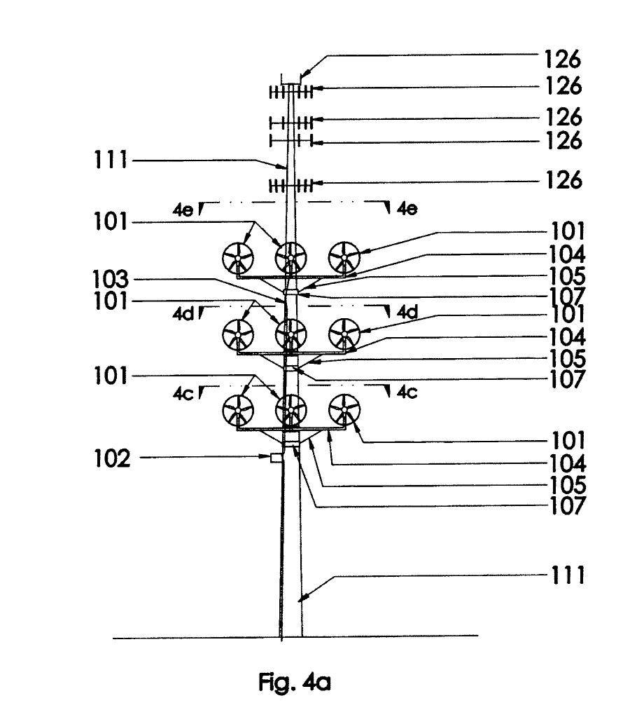

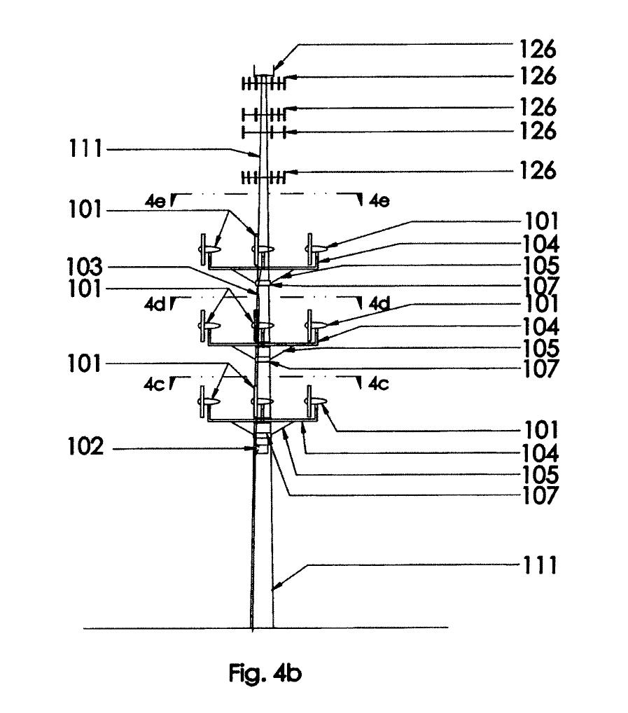

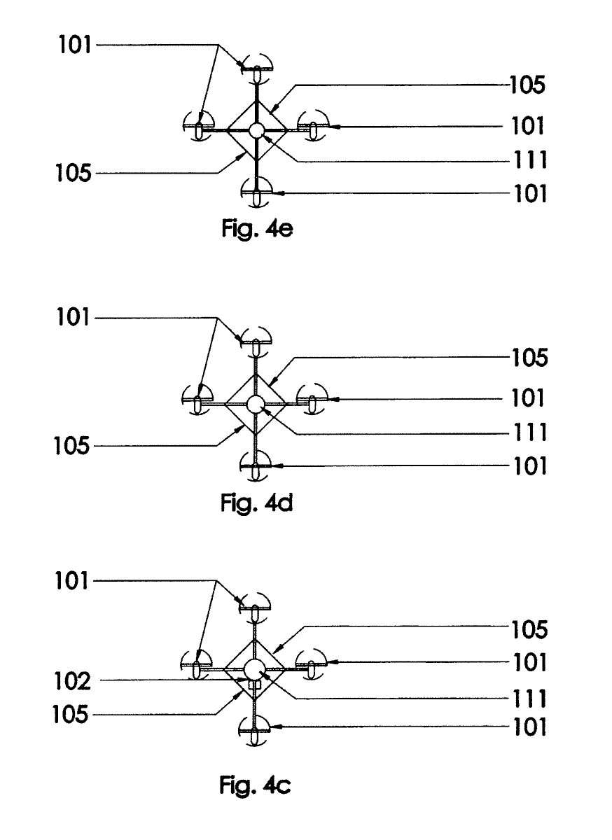

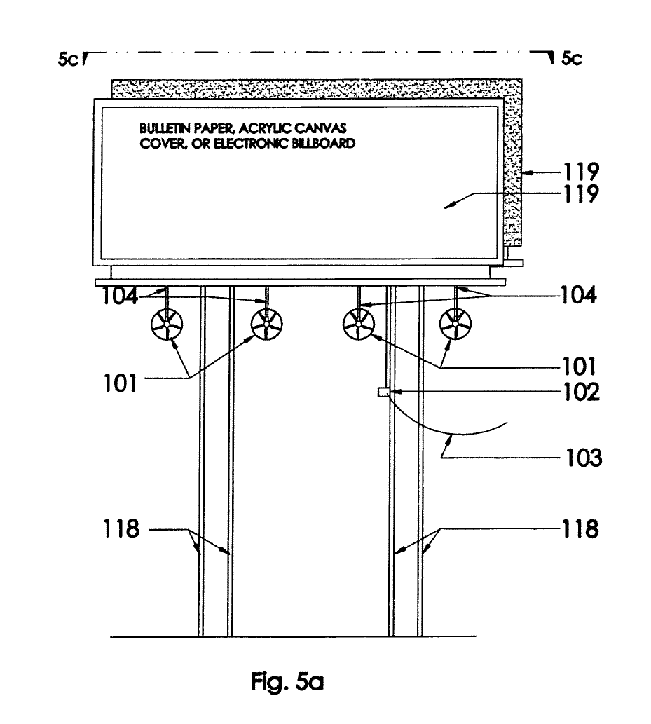

Referring to FIGS. 4a to 4e, 7a to 7d, 8a to 8d, 9a to 9b and 13a, in another example embodiment, pole support 104 may be horizontal and diagonal brace 105 and/or pole collar support element 107 may be used to further secure turbine systems 101. Any other support or mounting system may be used as desired by one skilled in the art.

Referring now to FIGS. 1a to 16c, in one embodiment, each horizontal axis wind turbine system 101 may be connected to a cable 103 which is connected to one common electrical gang meter or electrical meter box 102. Electrical meter box 102 monitors and records each of the horizontal axis wind turbine systems 101 individually for its production ratio against the other horizontal axis wind turbine systems mounted on the tower or structure 100. In another embodiment, electrical cable 103 extending from meter box 102 may serve as a collector cable from the tower or structure 100, which may connect to other towers or structures, and then may run to a nearby utility substation for distribution. Electrical cable 103 may supply newly created electrical energy directly to the local electrical grid system and may be governed according to the participating utility authority.

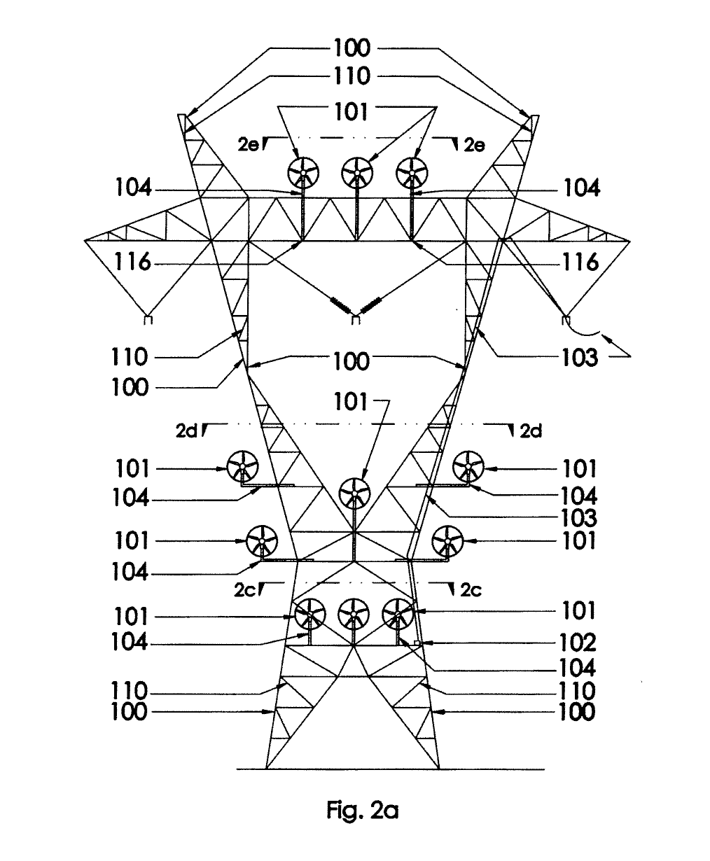

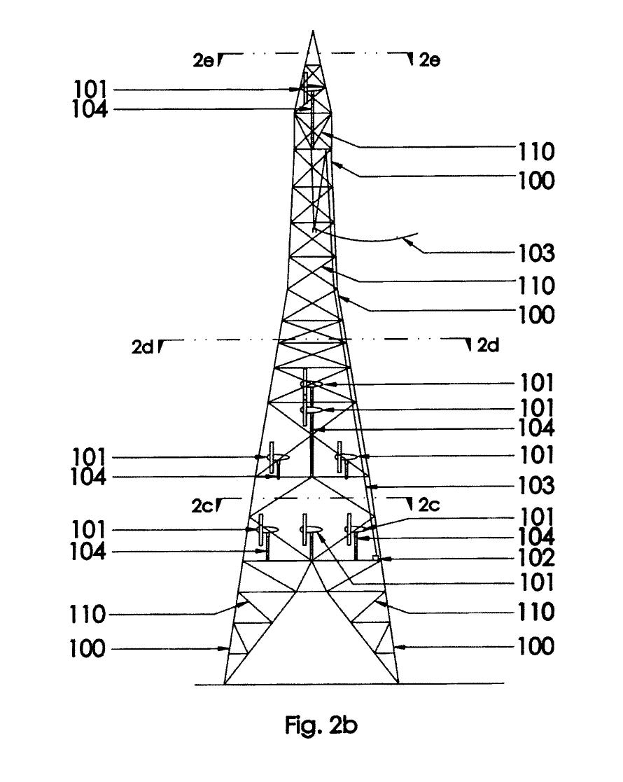

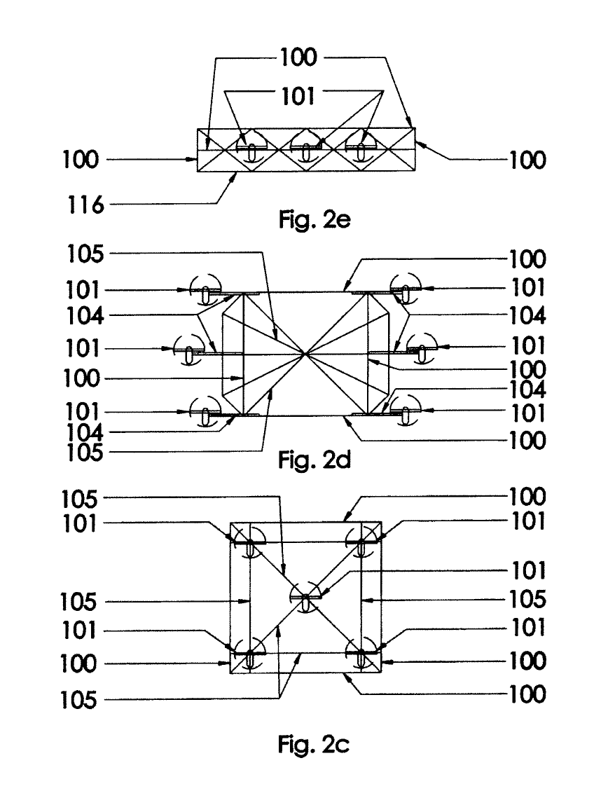

Referring now to FIGS. 2a to 2e, in an example embodiment, an apparatus that utilizes wind power to generate electricity comprising a plurality of horizontal axis wind turbine systems 101 mounted onto a transmission tower 100 having diagonal framing 110 is disclosed. In another example embodiment, fourteen horizontal axis wind turbine systems 101 are mounted onto transmission tower 100. Due to individual specifications of transmission tower 100, fourteen horizontal axis wind turbine systems 101 may be mounted on the interior and on the exterior of the transmission tower 100 at varying levels. The total number of horizontal axis wind turbine systems 101 mounted on tower 100 may vary as desired by one skilled in the art. Horizontal axis wind turbine systems 101 may be mounted to tower 100 with pole supports 104 and mounting system previously disclosed. Referring to FIG. 2c, in one embodiment, five horizontal axis wind turbine systems 101 are mounted on a first level of the apparatus of FIGS. 2a and 2b at the line 2c-2c. Referring to FIG. 2d, in one embodiment, six horizontal axis wind turbine systems 101 may be mounted on a second level of the apparatus of FIGS. 2a and 2b at the line 12d-12d. Referring to FIG. 2e, in another embodiment, three horizontal axis wind turbine systems 101 may be mounted on a third level (or horizontal truss 116) of the tower 100 of FIGS. 2a and 2b at the line 2e-2e. In one embodiment, each horizontal axis wind turbine system 101 may be connected with a cable 103 to one common electrical gang meter or electrical meter box 102. Electrical meter box 102 monitors and records each of the horizontal axis wind turbine systems 101 individually for its production ratio against the other horizontal axis wind turbine systems 101 mounted on the tower 100. In another embodiment, electrical cable 103 extending from meter box 102 will then be serving as a collector cable from the tower 100, which may connect to other towers or structures, and then may run to a nearby utility substation for distribution. Electrical cable 103 may supply newly created electrical energy directly to the local electrical grid system and may be governed according to the participating utility authority.

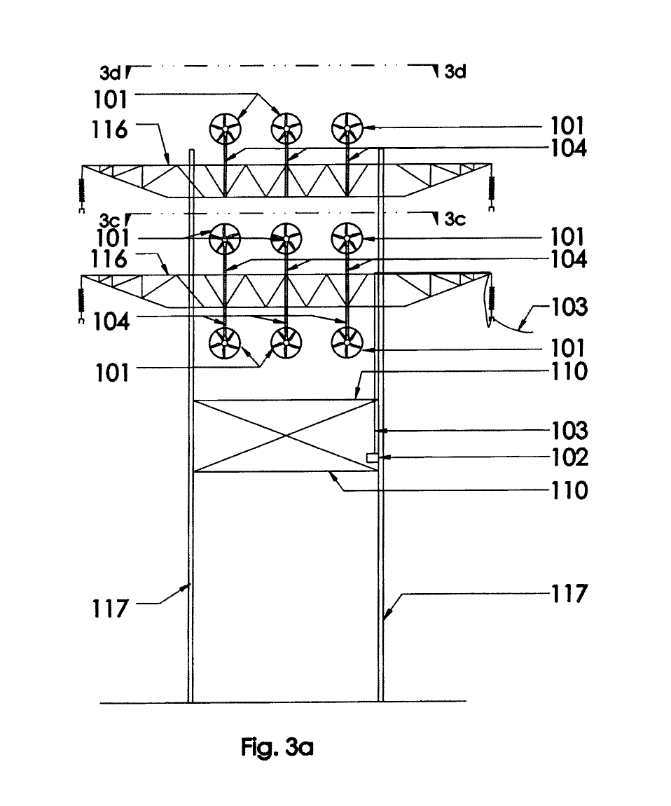

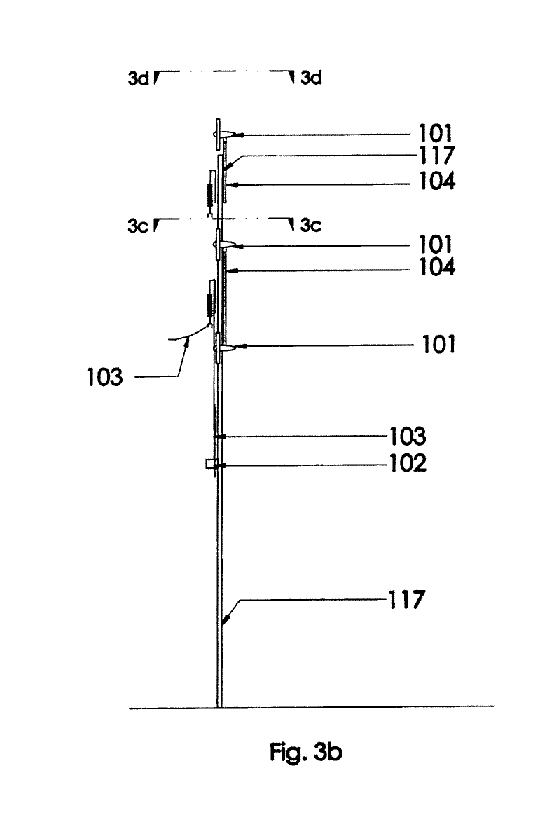

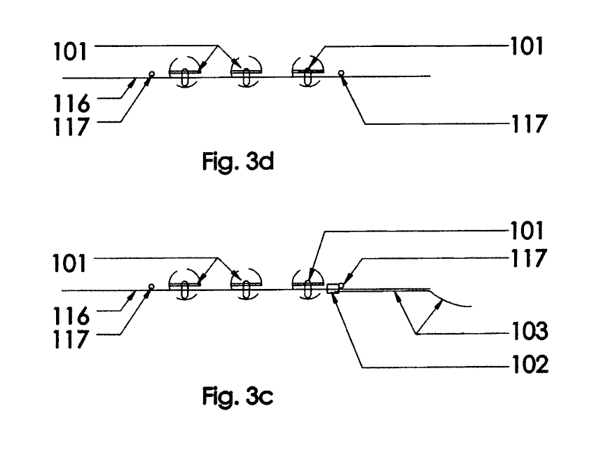

Referring to FIGS. 3a to 3d, in a further example embodiment, transmission tower 100 may be a twin pole transmission tower having two horizontal trusses 116 supported by two poles 117. In one embodiment, the twin pole transmission tower may be made of steel. In another embodiment, the twin pole transmission tower may be made of wood. The twin pole transmission tower may be made of any other material as desired by one skilled in the art. In one example embodiment, the tower 100 comprises nine horizontal axis wind turbine systems 101 mounted to tower 100 by pole support 104 and mounting systems as previously disclosed. The total number of horizontal axis wind turbine systems 101 may vary as desired by one of skill in the art. Referring to FIG. 3c, in one embodiment, six horizontal axis wind turbine systems 101 may be mounted on a first horizontal truss 116 of the apparatus of FIGS. 3a and 3b at the line 3c-3c. Referring to FIG. 3d, in another embodiment, three horizontal axis wind turbine systems 101 may be mounted on a second horizontal truss 116 of the apparatus of FIGS. 3a and 3b at the line 3d-3d. In one embodiment, each horizontal axis wind turbine system 101 may be connected to a cable 103 which is connected to one common electrical gang meter or electrical meter box 102. Electrical meter box 102 monitors and records each of the horizontal axis wind turbine systems 101 individually for its production ratio against the other horizontal axis wind turbine systems mounted on the tower. In another embodiment, electrical cable 103 extending from meter box 102 may serve as a collector cable from the tower, which may connect to other towers or structures, and then may run to a nearby utility substation for distribution. Electrical cable 103 may supply newly created electrical energy directly to the local electrical grid system and may be governed according to the participating utility authority.

Referring now to FIGS. 4a to 4e, the apparatus that utilizes wind power to generate electricity comprises a high rise monopole transmission tower 111 having electronic radio transmitter antenna 126. In one embodiment, the apparatus comprises twelve horizontal axis wind turbine systems 101. The number of horizontal axis wind turbine systems 101 may vary as desired by one skilled in the art. The horizontal axis wind turbine systems 101 may be mounted onto transmission tower 111 with horizontal pole support 104. Diagonal brace support 105 and pole collar support element 107 may also be used to mount wind turbine systems 101. Referring to FIGS. 4c to 4e, in one embodiment, four horizontal axis wind turbine systems 101 may be mounted on a first level, second level and third levels of the apparatus of FIGS. 4a and 4b at the lines 4c-4c, 4d-4d, and 4e-4e respectively. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the tower. In another embodiment, electrical cable 103 extending from meter box 102 may serve as a collector cable from the tower 111, which may connect to other towers or structures, and then may run to a nearby utility substation for distribution. Electrical cable 103 may supply newly created electrical energy directly to the local electrical grid system and may be governed according to the participating utility authority.

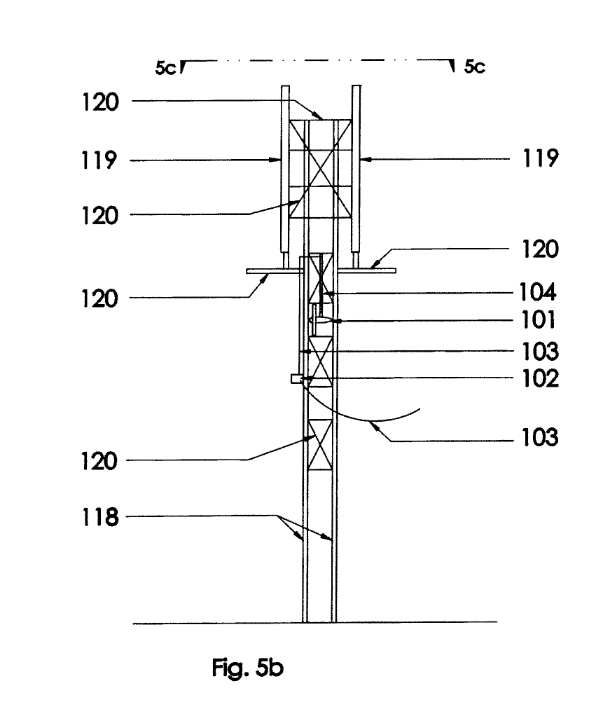

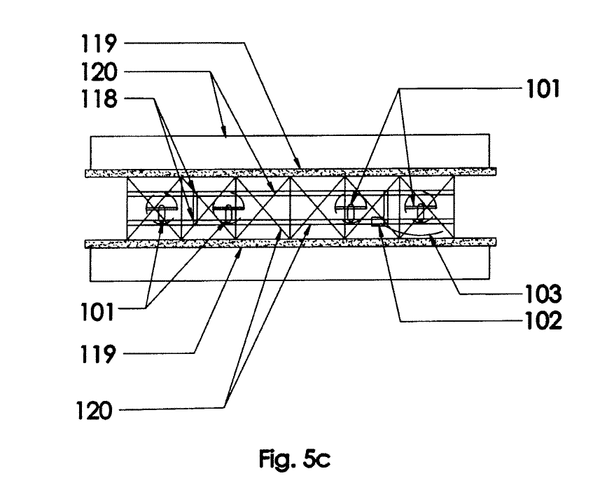

Referring now to FIGS. 5a to 5c, in one embodiment, the apparatus that utilizes wind power to generate electricity comprises a billboard 119 with support structure having a primary steel leg pole support 118 and secondary structural steel framing support 120 (see FIG. 5b). The billboard 119 may comprise a bulletin paper, acrylic canvas cover, or electronic billboard. Any other type billboard 119 may be used as desired by one skilled in the art. In one embodiment, the apparatus comprises four horizontal axis wind turbine systems 101. The number of horizontal axis wind turbine systems 101 may vary as desired by one skilled in the art. The horizontal axis wind turbine systems 101 are mounted onto the secondary structural steel framing support 120 with vertical pole support 104 and mounting system shown in FIGS. 17a to 17h. Referring to FIG. 5c, four horizontal axis wind turbine systems 101 may be mounted on the apparatus of FIGS. 5a and 5b at the line 5c-5c. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the apparatus. In another embodiment, electrical cable 103 extending from meter box 102 may serve as a collector cable from the apparatus, which may connect to other towers or structures, and then may run to a nearby utility substation for distribution. Electrical cable 103 may supply newly created electrical energy directly to the local electrical grid system and may be governed according to the participating utility authority.

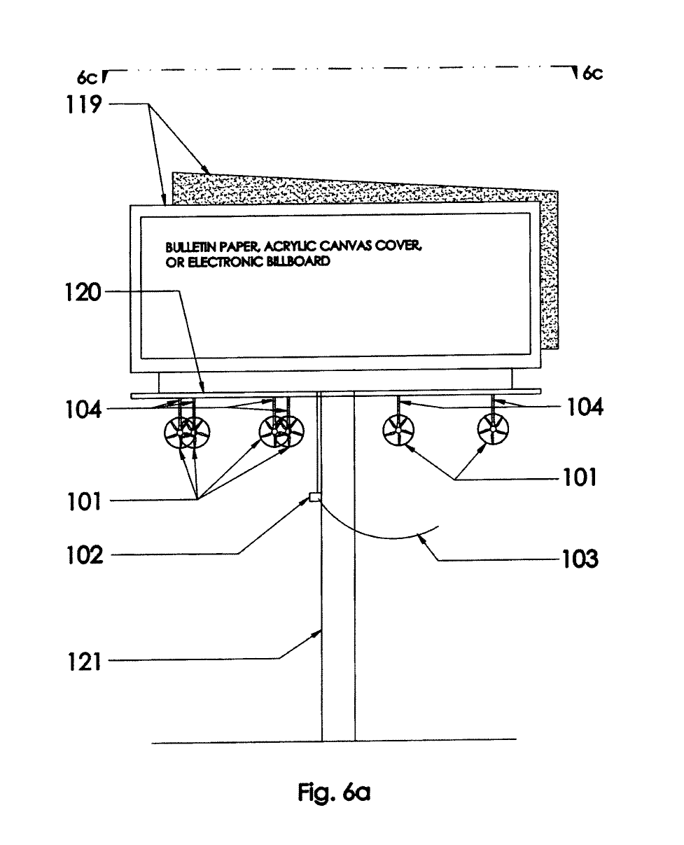

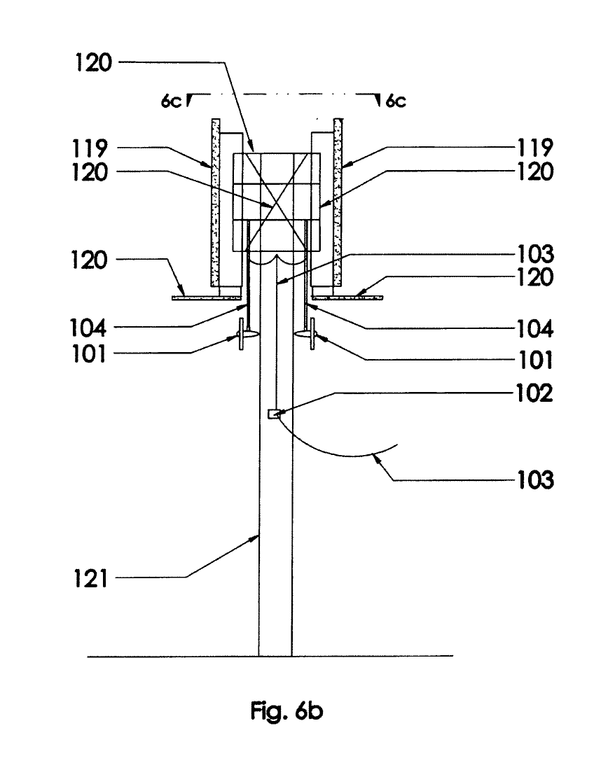

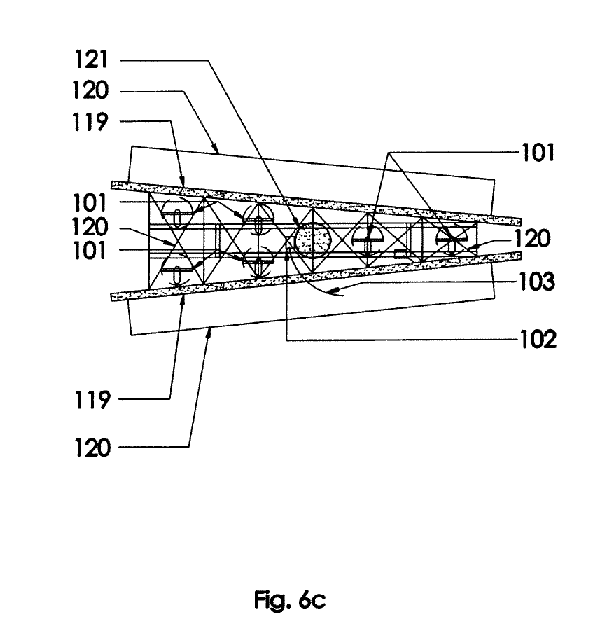

Referring now to FIGS. 6a to 6c, in another embodiment, the apparatus that utilizes wind power to generate electricity comprises a billboard 119 with support structure having a monopole support 121 and secondary structural framing support 120. In one embodiment, the support structure 121 and 120 may be made of steel but may be made of other materials as desired by one of skill in the art. The billboard 119 may comprise a bulletin paper, acrylic canvas cover, or electronic billboard. Any other type billboard 119 may be used as desired by one skilled in the art. In one example embodiment, the apparatus comprises two billboards 119 forming an angle. In one embodiment, the apparatus comprises six horizontal axis wind turbine systems 101. The number of horizontal axis wind turbine systems 101 may vary as desired by one skilled in the art. The horizontal axis wind turbine systems 101 are mounted onto the secondary structure framing support 120 with vertical pole support 104. Referring to FIG. 6c, six horizontal axis wind turbine systems 101 are shown mounted on the apparatuses of FIGS. 6a and 6b at the line 6c-6c. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the apparatus. In another embodiment, electrical cable 103 extending from meter box 102 may serve as a collector cable from the apparatus, which may connect to other towers or structures, and then may run to a nearby utility substation for distribution. Electrical cable 103 may supply newly created electrical energy directly to the local electrical grid system and may be governed according to the participating utility authority.

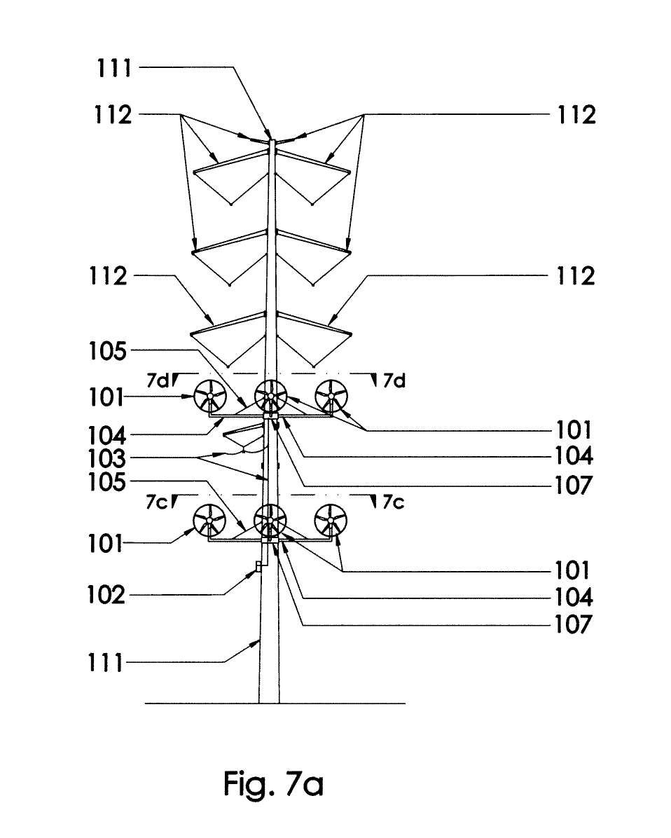

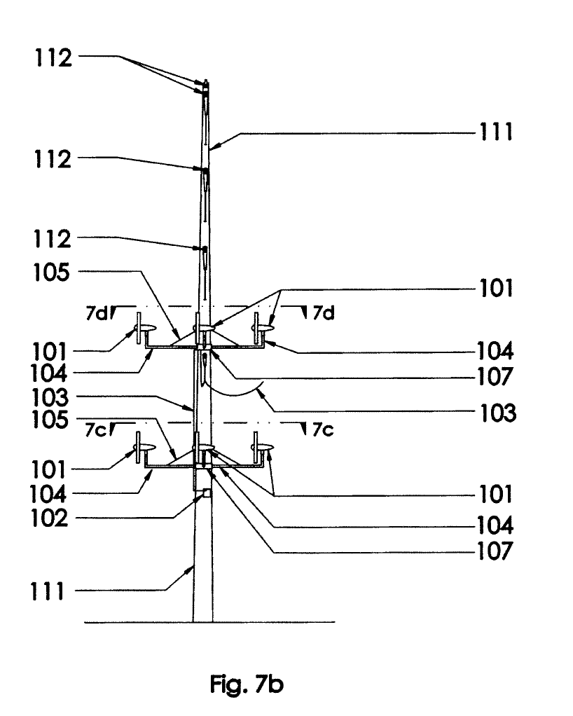

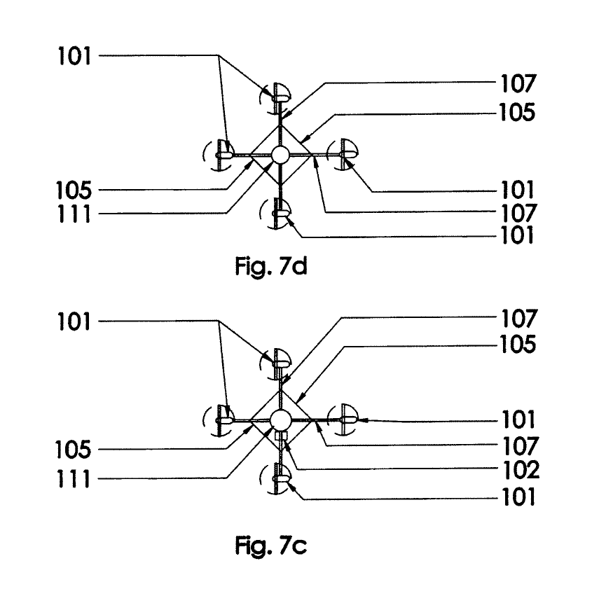

Referring now to FIGS. 7a to 7c, in still a further embodiment, the apparatus that utilizes wind power to generate electricity comprises a high rise monopole transmission tower 111 having extension arms 112 which support high power transmission cables. In one embodiment, eight horizontal axis wind turbine systems 101 are mounted to the high rise monopole transmission tower 111, however, any number of turbine systems 101 may be mounted to transmission tower 111 as desired by one skilled in the art. The horizontal axis wind turbine systems 101 may be mounted onto transmission tower 111 with horizontal and/or vertical pole support 104. Diagonal brace 105 and/or pole collar support element 107 may also be used to mount wind turbine systems 101 to the tower 111. In one embodiment, a fabricated galvanized metal turbine mounting rack may be used to mount four horizontal axis wind turbine systems 101 at each desired levels on tower 111. Referring to FIG. 7c, four horizontal axis wind turbine systems 101 are mounted on the transmission tower 111 of FIGS. 7a and 7b at the line 7c-7c. Referring to FIG. 7d, four horizontal wind turbine systems 101 are mounted on the transmission tower 111 of FIGS. 7a and 7b at the line 7d-7d. In one embodiment, each horizontal axis wind turbine system 101 may be connected with a cable 103 to one common electrical gang meter or electrical meter box 102. Electrical meter box 102 may monitor and record each of the horizontal axis wind turbine systems 101 individually for its production ratio against the other horizontal axis wind turbine systems mounted on the tower. In another embodiment, electrical cable 103 extending from meter box 102 may serve as a collector cable from the tower, which may connect to other towers and structures, and then may run to a nearby utility substation for distribution. Electrical cable 103 may supply newly created electrical energy directly to the local electrical grid system and may be governed according to the participating utility authority.

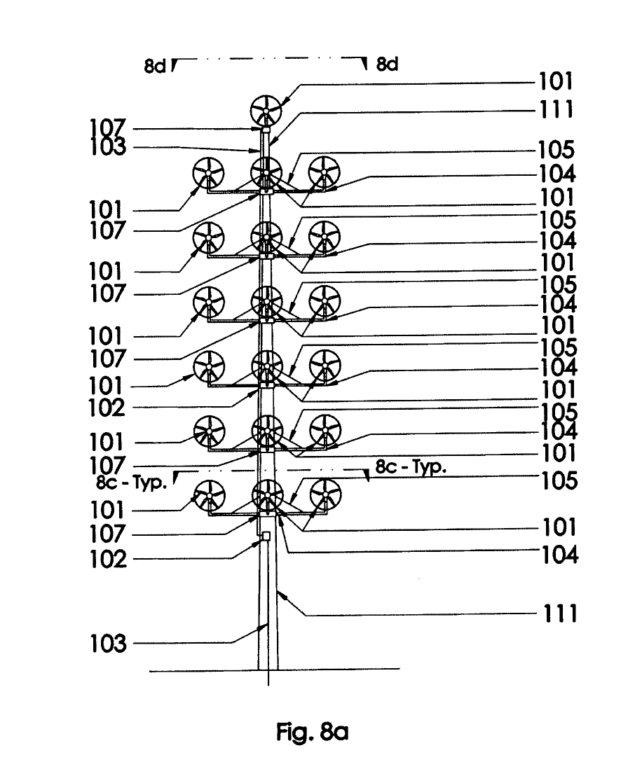

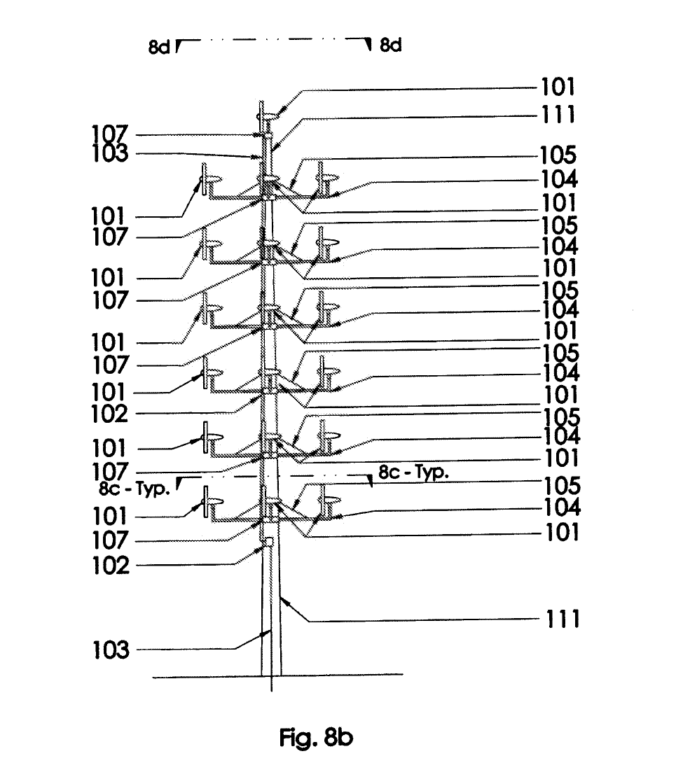

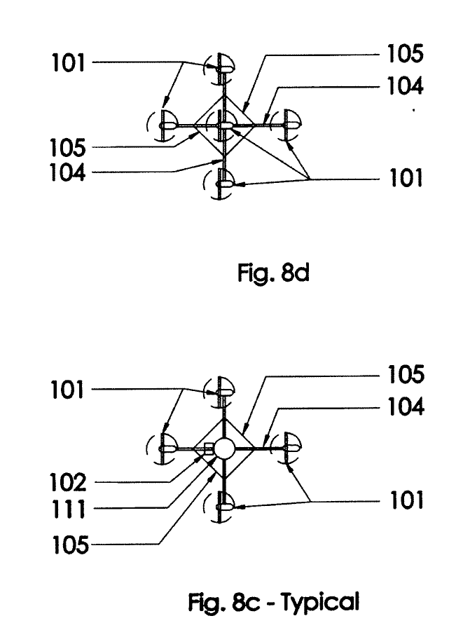

Referring now to FIGS. 8a to 8d, in one embodiment, the apparatus utilizes wind power to generate electricity and comprises a plurality of horizontal axis wind turbine systems 101 mounted onto a high rise monopole tower 111. In one embodiment, the tower 111 is made of steel but any other material may be used as desired by one skilled in the art. In one example embodiment, the apparatus comprises twenty-five horizontal axis wind turbine systems 101 allowing the apparatus to create approximately one megawatt of electricity. Any number of horizontal axis wind turbine systems 101 may be used as desired by one skilled in the art. The horizontal axis wind turbine systems 101 may be mounted onto transmission tower 111 with horizontal and/or vertical pole support 104. Diagonal brace 105 and/or pole collar support element 107 may also be used to mount wind turbine systems 101 to tower 111. In one embodiment, each horizontal axis wind turbine system 101 may be connected to cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the apparatus. In another embodiment, electrical cable 103 extending from meter box 102 may serve as a collector cable from the apparatus, which may connect to other towers or structures, and then may run to a nearby utility substation for distribution. Electrical cable 103 may supply newly created electrical energy directly to the local electrical grid system and may be governed according to the participating utility authority.

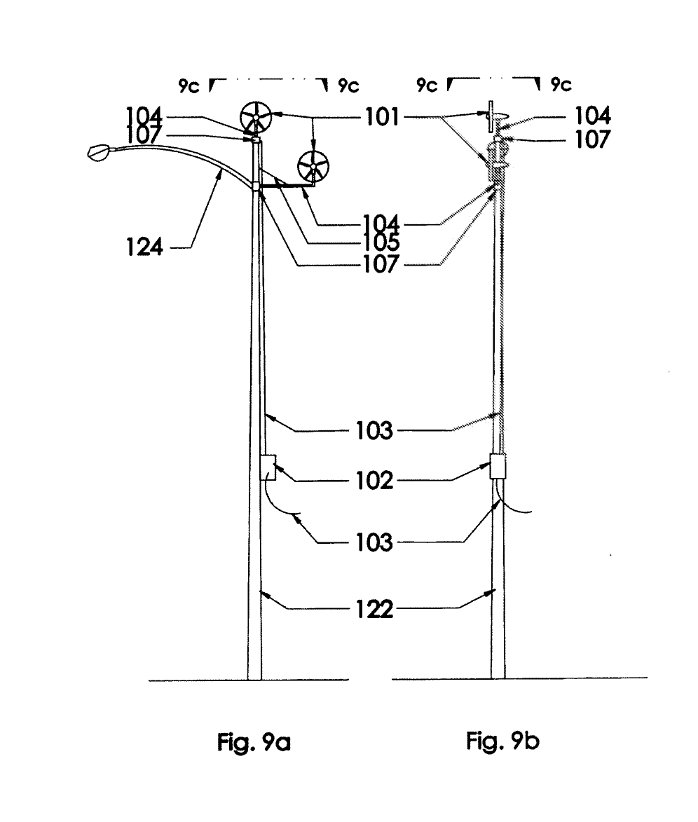

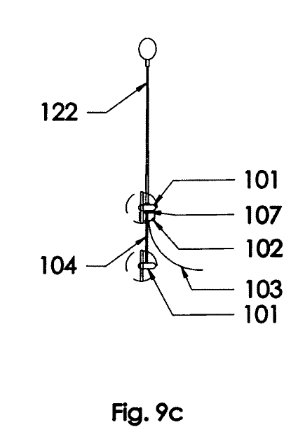

Referring now to FIGS. 9a to 9c, in another embodiment, the apparatus utilizes wind power to generate electricity comprising at least one horizontal axis wind turbine system 101 mounted onto a support pole 122 of a single electrical light fixture 124. In one embodiment, the apparatus comprises two horizontal axis wind turbine systems 101 mounted onto an existing support pole 122 of a single electrical light fixture having support arm 124. Any number of wind turbine systems 101 may be used as desired by one skilled in the art. In one example embodiment, one turbine system 101 is mounted on top of the support pole 122 with pole support 104 and pole collar support element 107. In another example embodiment, one turbine system 101 is mounted by way of horizontal pole support 104, diagonal bracing support 105 and pole collar support element 107. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the apparatus. In another embodiment, electrical cable 103 extending from meter box 102 may serve as a collector cable from the apparatus, which may connect to other towers or structures and then may run to a nearby utility substation for distribution. Electrical cable 103 may supply newly created electrical energy directly to the local electrical grid system and may be governed according to the participating utility authority.

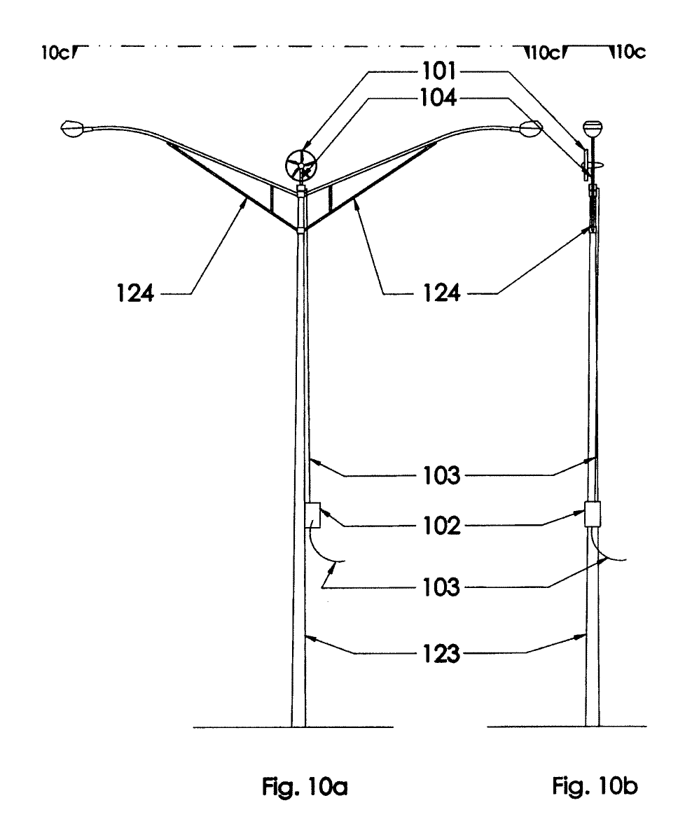

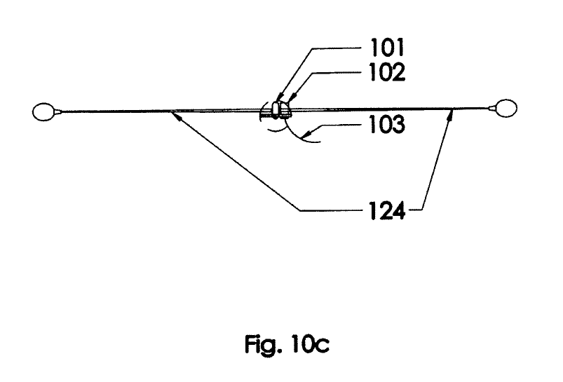

Referring now to FIGS. 10a to 10c, in another embodiment, the apparatus utilizes wind power to generate electricity comprising at least one horizontal axis wind turbine system 101 mounted onto a support pole 123 of a double electrical light fixture having support arms 124. In one embodiment, the apparatus comprises one horizontal axis wind turbine system 101 mounted onto support pole 123 of a double electrical light fixture. Additional wind turbine systems 101 may be used as desired by one skilled in the art. In one example embodiment, one turbine system 101 is mounted on top of the support pole 123 with pole support 104 and pole collar support element 107. In one embodiment, horizontal axis wind turbine system 101 may be connected to cable 103, which is connected to electrical gang meter or electrical meter box 102. Electrical meter box 102 may monitor and record the horizontal axis wind turbine systems 101 individually for its production ratio. In another embodiment, electrical cable 103 extending from meter box 102 may serve as a collector cable from the apparatus, which may connect to other towers or structures, and then may run to a nearby utility substation for distribution. Electrical cable 103 may supply newly created electrical energy directly to the local electrical grid system and may be governed according to the participating utility authority.

Referring now to FIGS. 11a to 11c, in a further example embodiment, the apparatus utilizes wind power to generate electricity comprising a plurality of horizontal axis wind turbine systems 101 mounted onto a support structure of a water tank 115. The support structure comprises primary legs 113 and secondary framing 114. In one embodiment, the apparatus comprises one hundred and twenty-eight horizontal axis wind turbine systems 101 mounted onto primary legs 113 of water tank 115. Any number of wind turbine systems 101 may be used as desired by one skilled in the art. In one embodiment, four horizontal axis wind turbine systems may be mounted onto the support structure of the water tank 115 at each desired level. In one embodiment, a galvanized metal support rack, using mounting system shown in FIGS. 17a to 17h, may be fabricated and used to mount the four turbine systems 101. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the apparatus. In another embodiment, electrical cable 103 extending from meter box 102 may serve as a collector cable from the apparatus, which may connect to other towers or structures, and then may run to a nearby utility substation for distribution. Electrical cable 103 may supply newly created electrical energy directly to the local electrical grid system and may be governed according to the participating utility authority.

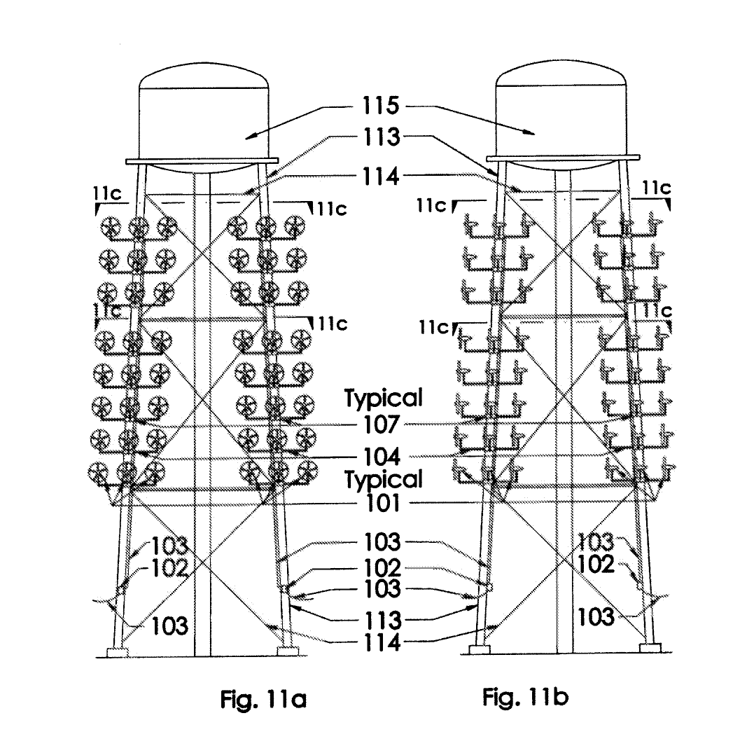

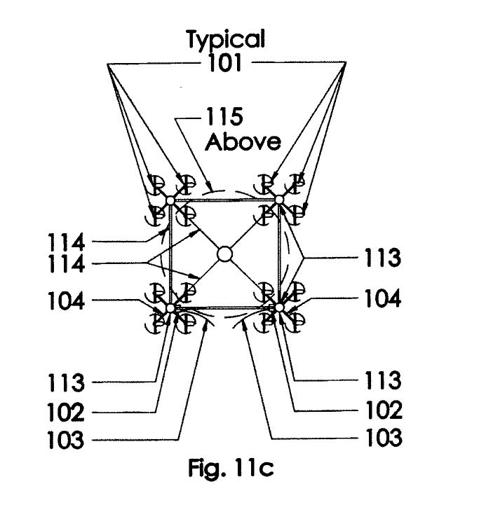

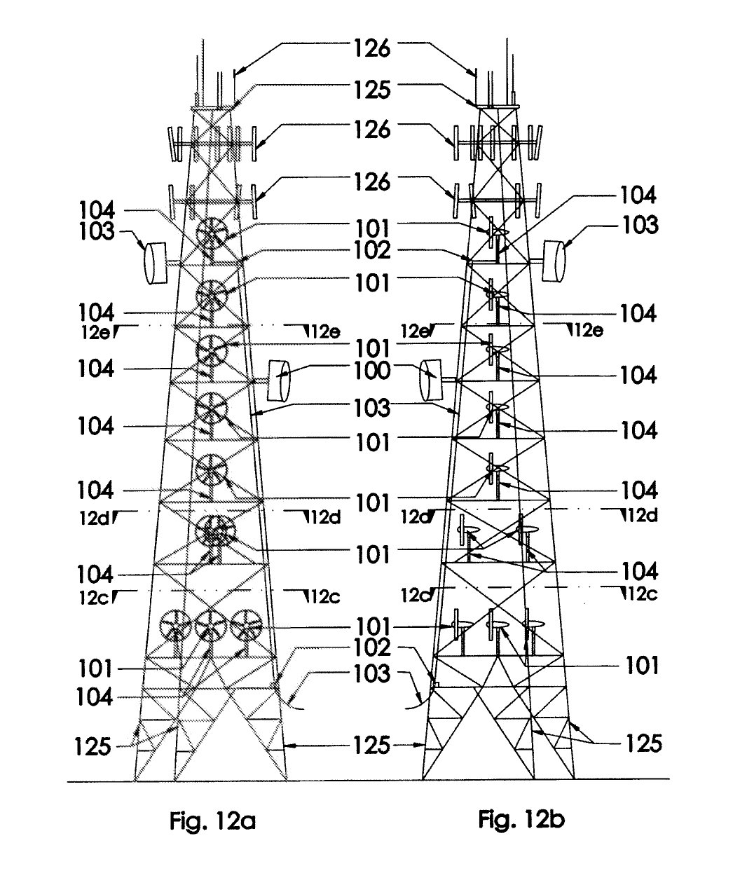

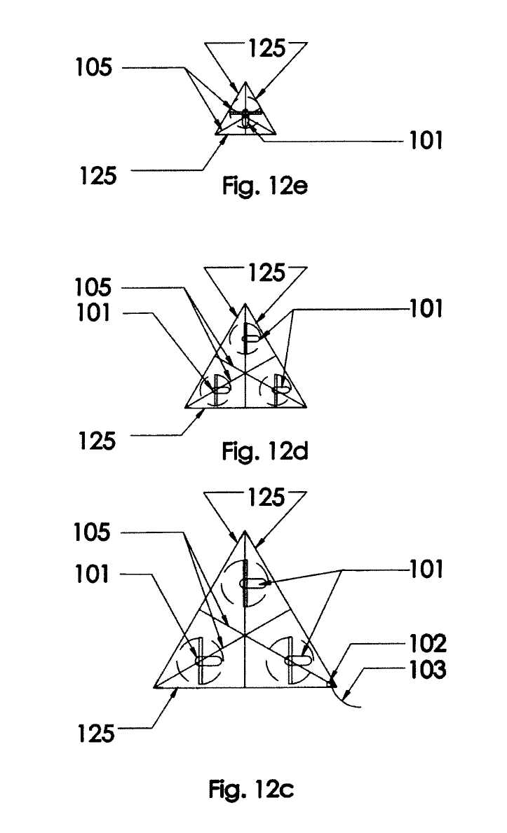

Referring now to FIGS. 12a to 12c, in one embodiment, the apparatus utilizes wind power to generate electricity comprising a plurality of horizontal axis wind turbine systems mounted onto a transmission tower 125 having electronic radio transmitter antenna 126. In one embodiment, transmission tower 125 is a primary steel tower for private, commercial or governmental electronic receiving and transmission. In one embodiment, tower 125 has eleven turbine systems 101. Any number of wind turbine systems 101 may be used as desired by one skilled in the art. In one embodiment, horizontal wind turbine systems 101 are mounted to tower 125 with mounting system disclosed in FIGS. 17a to 17h. Mounting system may be customized for each tower or structure depending on the individual specifications and dimensions of the tower or structure. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the tower 125. In another embodiment, electrical cable 103 extending from meter box 102 may serve as a collector cable from the tower 125, which may connect to other towers or structures, and then may run to a nearby utility substation for distribution. Electrical cable 103 may supply newly created electrical energy directly to the local electrical grid system and may be governed according to the participating utility authority.

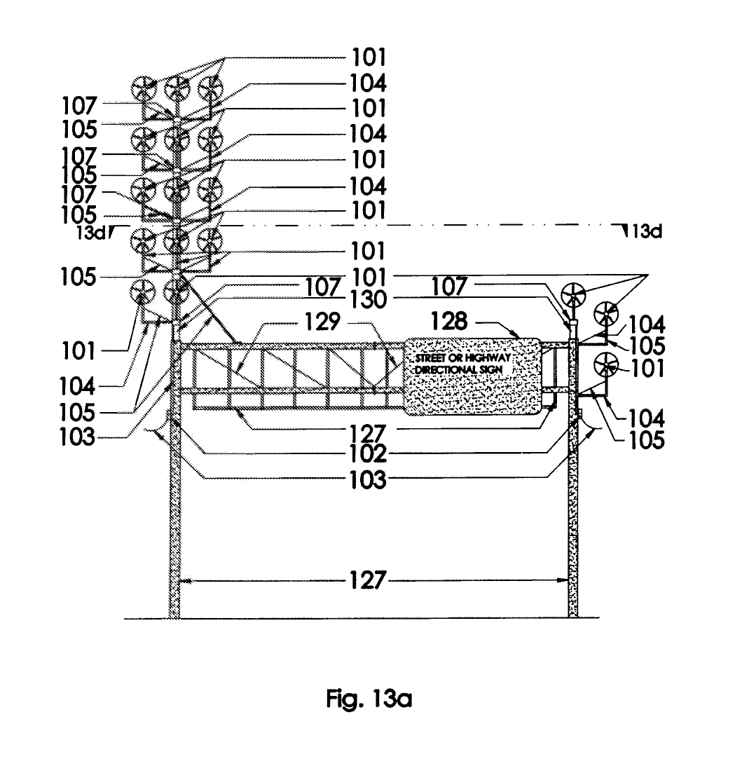

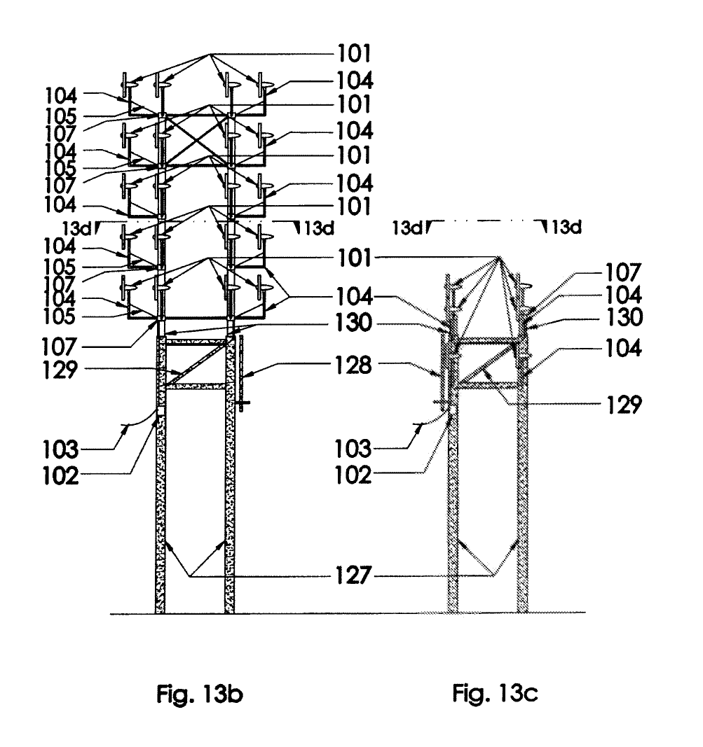

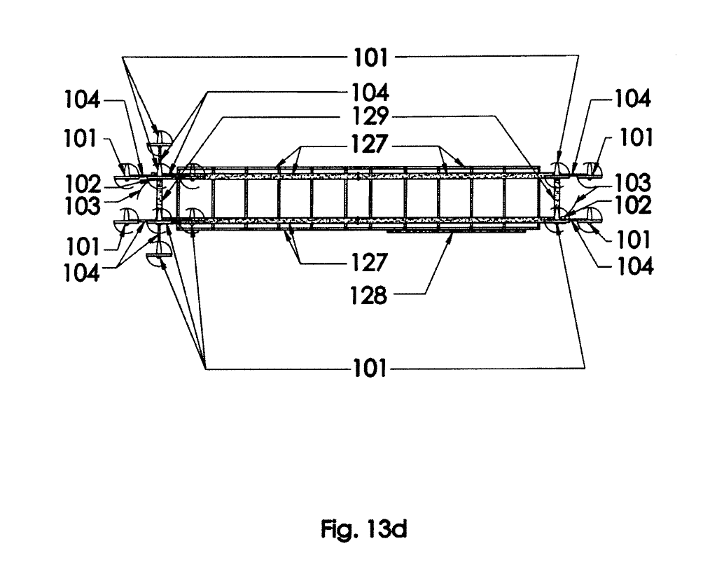

Referring now to FIGS. 13a to 13d, in another embodiment, the apparatus utilizes wind power to generate electricity. The apparatus comprises a plurality of horizontal axis wind turbine systems 101 mounted onto the support structure 127 of overhead highway directional billboard 128, which aids vehicular traffic. The support structure 127 comprises left and right columns and overhead structural truss assembly. The truss assembly is supported by framing 129. Each side of support structure 127 depicts a possible configuration for the incorporation of a plurality of horizontal axis wind turbine systems 101 onto the support structure 127 of a highway directional billboard 128. The number of horizontal wind turbine systems 101 may vary as desired by one skilled in the art. In one embodiment, horizontal wind turbine systems 101 are mounted to the structure with mounting system disclosed in FIGS. 17a to 17h. Mounting system may be customized for each tower or structure depending on the individual specifications and dimensions of the tower or structure. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the apparatus. In another embodiment, electrical cable 103 extending from meter box 102 may serve as a collector cable from the apparatus, which may connect to other towers or structures, and then may run to a nearby utility substation for distribution. Electrical cable 103 may supply newly created electrical energy directly to the local electrical grid system and may be governed according to the participating utility authority.

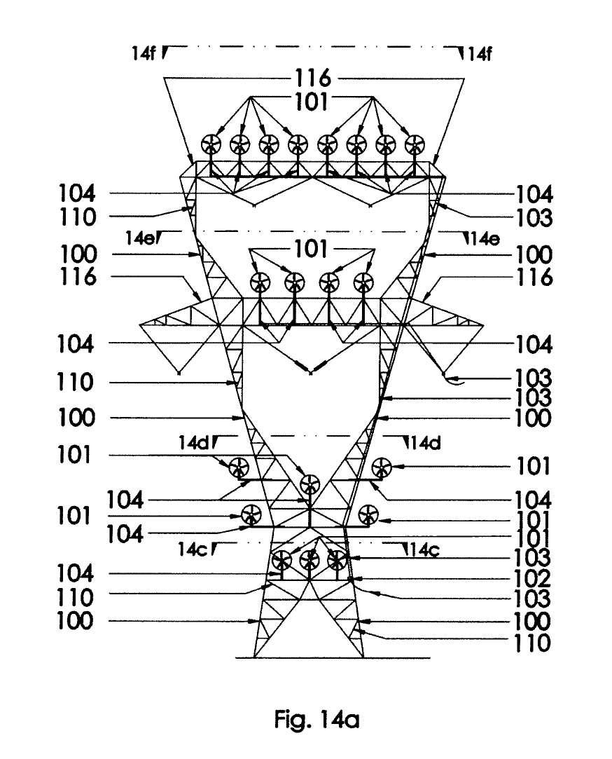

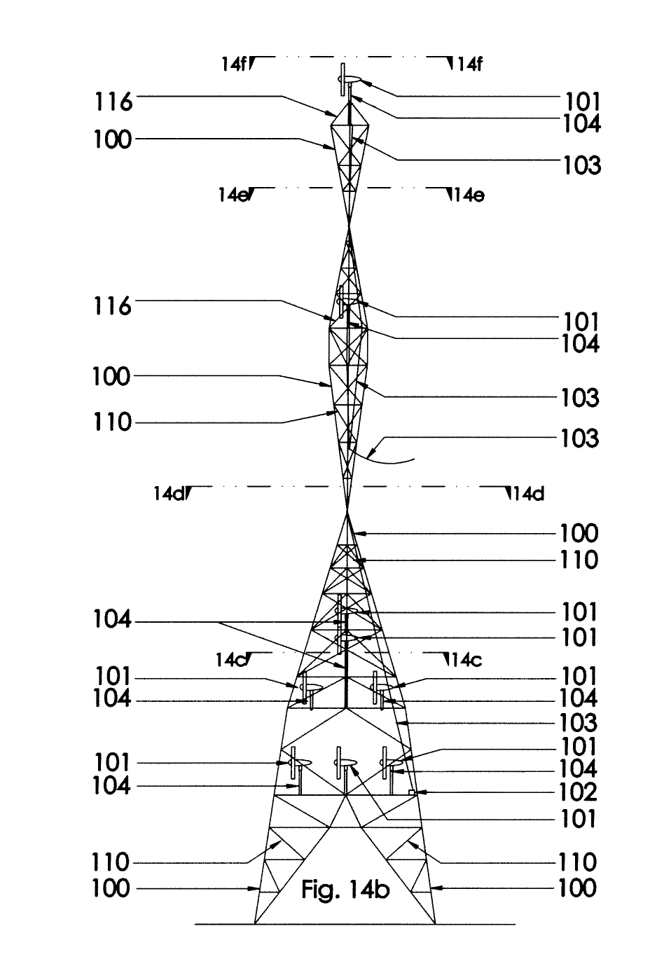

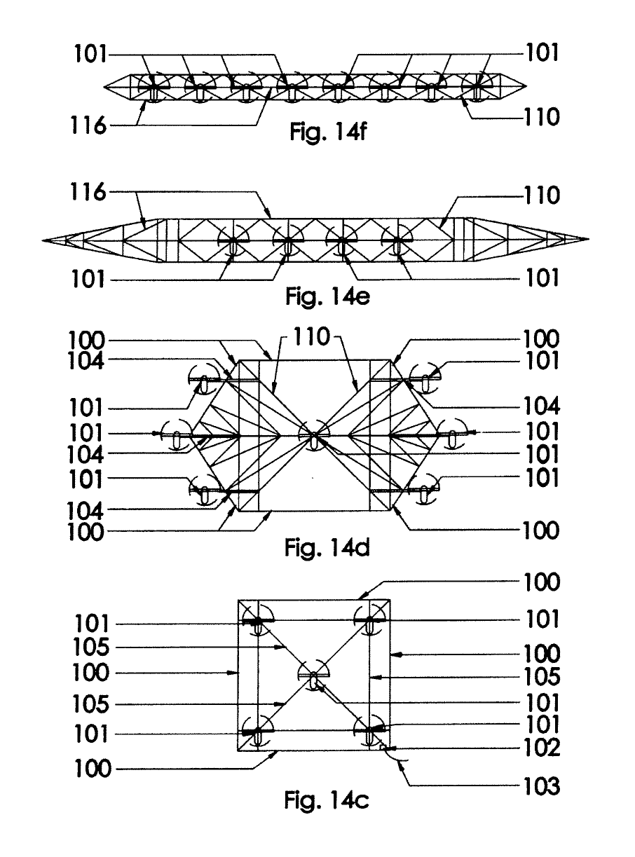

Referring now to FIGS. 14a to 14f, in yet a further embodiment, the apparatus utilizing wind power to generate electricity comprises a plurality of horizontal axis wind turbine systems 101 mounted onto a transmission tower 100 with diagonal framing support 110. In one embodiment, the tower 100 comprises two horizontal trusses 116 on which turbine systems 101 may be mounted. In one embodiment, horizontal wind turbine systems 101 are mounted to the tower with mounting system disclosed in FIGS. 17a to 17h. Mounting system may be customized for each tower or structure depending on the individual specifications and dimensions of the tower or structure. In one embodiment, twenty four turbine systems 101 may be mounted on tower 100. The number of horizontal wind turbine systems 101 may vary as desired by one skilled in the art. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the tower 100. In another embodiment, electrical cable 103 extending from meter box 102 may serve as a collector cable from the tower 100, which may connect to other towers or structures, and may then run to a nearby utility substation for distribution. Electrical cable 103 may supply newly created electrical energy directly to the local electrical grid system, and may be governed according to the participating utility authority.

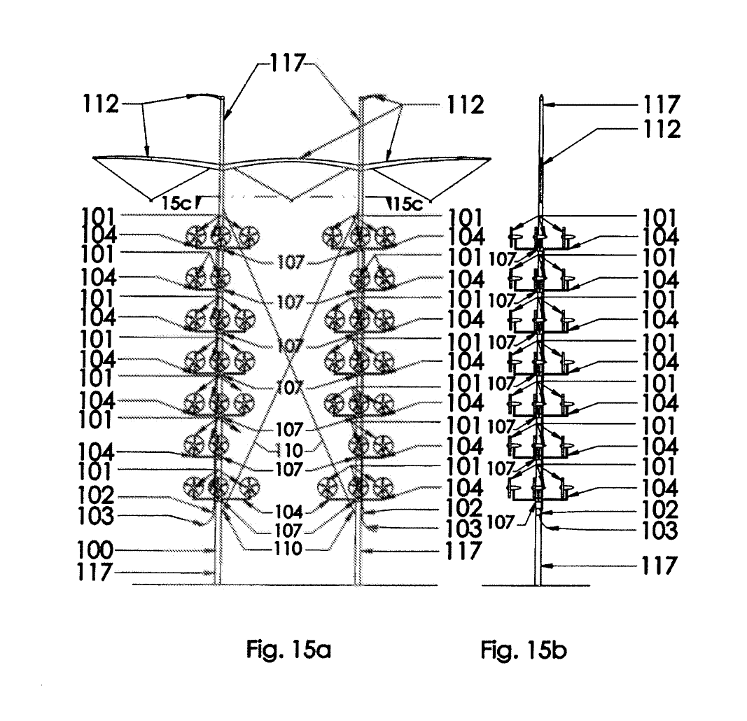

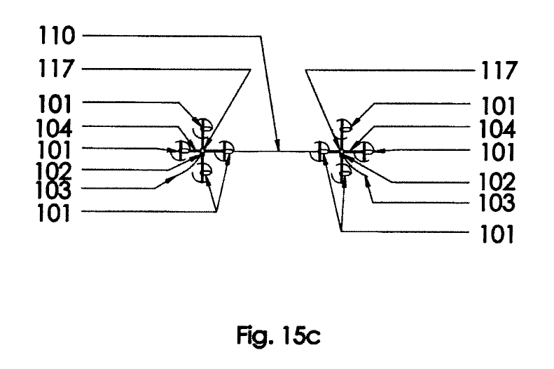

Referring now to FIGS. 15a to 15c, in another embodiment, the apparatus utilizing wind power to generate electricity comprises a plurality of horizontal axis wind turbine systems 101 mounted onto a twin pole transmission tower having twin poles 117 and extension arms 112 which support high power transmission cables. In one embodiment, the apparatus comprises two diagonal cables 110 which support the movement of the twin poles 117. In one embodiment, fifty-two turbine systems 101 may be mounted on the apparatus. The number of horizontal wind turbine systems 101 may vary as desired by one skilled in the art. In one embodiment, each horizontal axis wind turbine system 101 may be connected with a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the apparatus. In another embodiment, electrical cable 103 extending from meter box 102 may serve as a collector cable from the apparatus, which may connect to other towers or structures, and then may run to a nearby utility substation for distribution. Electrical cable 103 may supply newly created electrical energy directly to the local electrical grid system and may be governed according to the participating utility authority.

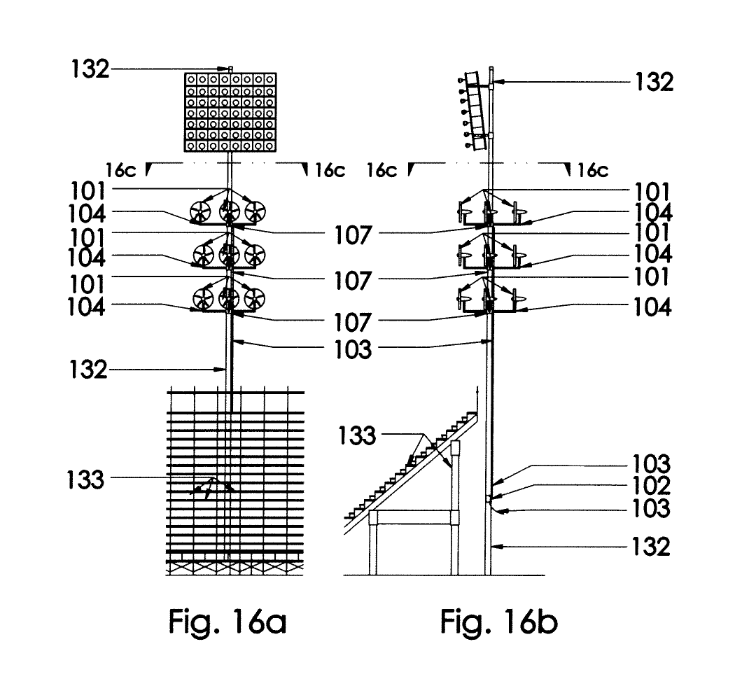

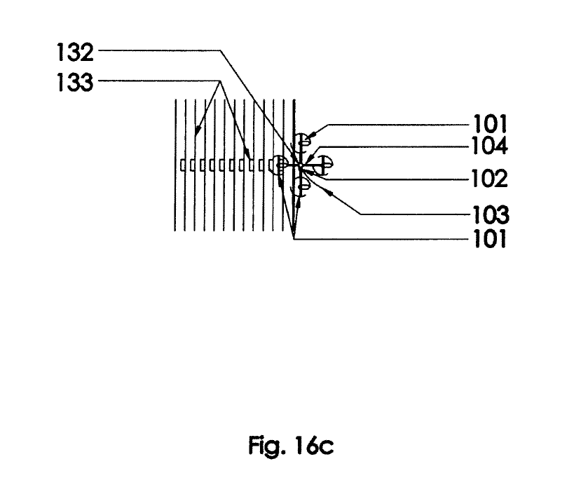

Referring now to FIGS. 16a to 16c, in yet another embodiment, the apparatus utilizes wind power to generate electricity comprising a plurality of horizontal axis wind turbine systems 101 mounted onto light standards 132. In one embodiment, the light standards 132 may be outdoor activity field, electrical steel or wood light standards for the support of multiple electrical field lights. In one embodiment, twelve turbine systems 101 may be mounted on the light standard 132. The number of horizontal wind turbine systems 101 may vary as desired by one skilled in the art. In one embodiment, each horizontal axis wind turbine system 101 may be connected to a cable 103, which is connected to one common electrical gang meter or electrical meter box 102. Electrical meter box 102 may monitor and record each of the horizontal axis wind turbine systems 101 individually for its production ratio against the other horizontal axis wind turbine systems mounted on the apparatus. In another embodiment, electrical cable 103 extending from meter box 102 may serve as a collector cable from the apparatus, which may connect to other towers or structures, and then may run to a nearby utility substation for distribution. Electrical cable 103 may supply newly created electrical energy directly to the local electrical grid system and may be governed according to the participating utility authority.

A method that utilizes wind power to generate electricity is also disclosed. The method comprises the steps of mounting a plurality of small horizontal axis wind turbine systems to any new or existing structure.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof.

We claim:

1. An apparatus that utilizes wind power to generate electricity, the apparatus comprises:
a plurality of single horizontal axis wind turbine systems mounted independently in a predetermined location onto a pre-existing, land-based, fixed structure having steel framing, wherein the plurality of horizontal axis wind turbine systems are securely mounted to the framing of the structure with a mounting system, wherein each horizontal axis wind turbine system has a plurality of rotors each with a diameter of about 2.2 meters and is connected in series to a common cable, wherein the cable is connected to a utility substation for distribution and supplies newly created electrical energy to a local electrical grid system.

2. The apparatus of claim 1 wherein each rotor rotates about a small axis generator for creation of new alternating electrical energy, wherein the wind turbine assembly rotates 360 degrees horizontally about a pole support.

3. The apparatus of claim 1 wherein each horizontal axis wind turbine system comprises an electrical power specification of 240 volts of AC power at 60 hertz.

4. The apparatus of claim 1 wherein each horizontal axis wind turbine system comprises a grid connection of G83 Certified, and a grid-tied system.

5. The apparatus of claim 1 wherein each horizontal axis wind turbine system has a minimum clearance of about 0.6 meters.

6. The apparatus of claim 1 wherein each horizontal axis wind turbine system is mounted on the structure at about at least thirty feet above ground level.

7. The apparatus of claim 1 wherein the structure has a plurality of levels on which to mount one or more horizontal axis wind turbine systems.

8. The apparatus of claim 1 wherein the structure is a transmission tower.

9. The apparatus of claim 1 wherein the structure is a telecommunication tower.

10. The apparatus of claim 1 wherein the structure is a billboard support structure.

11. The apparatus of claim 1 wherein the structure is a support pole.

12. The apparatus of claim 11 wherein the support pole is a single electrical light fixture.

13. The apparatus of claim 11 wherein the support pole is a double electrical light fixture.

14. The apparatus of claim 1 wherein the structure is a support structure.

15. The apparatus of claim 14 wherein the support structure is a water tank.

16. The apparatus of claim 14 wherein the support structure is a directional billboard which aids vehicular traffic.

17. The apparatus of claim 1 wherein the structure is a light standard.

18. A method that utilizes wind power to generate electricity, the method comprising:
a. securing a plurality of horizontal axis wind turbine systems onto a pre-existing, land-based, fixed structure having steel framing, wherein the plurality of horizontal axis wind turbine systems are securely mounted to the framing of the structure with a mounting system, wherein each horizontal axis wind turbine system has a plurality of rotors each with a diameter of about 2.2 meters;
b. connecting in series each horizontal axis wind turbine system to a common cable, wherein the cable is connected to a utility substation for distribution and supplies newly created electrical energy to a local electrical grid system.

19. The method of claim 18 wherein each rotor rotates about a small axis generator for creation of new alternating electrical energy, wherein the wind turbine assembly rotates 360 degrees horizontally about a pole support.

20. The method of claim 18 wherein each horizontal axis wind turbine system comprises an electrical power specification of 240 volts of AC power at 60 hertz.

21. The method of claim 18 wherein each horizontal axis wind turbine system comprises a conventional connection to a G83 Certified Grid System.

22. The apparatus of claim 18 wherein each horizontal axis wind turbine system has a minimum clearance of about 0.6 meters.

23. The apparatus of claim 18 wherein each horizontal axis wind turbine system is mounted on the structure at about at least thirty feet above ground level.

24. The apparatus of claim 18 wherein the structure has a plurality of levels on which to mount one or more horizontal axis wind turbine systems.

25. The apparatus of claim 18 wherein the structure is a transmission tower.

26. The apparatus of claim 18 wherein the structure is a telecommunication tower.

27. The apparatus of claim 18 wherein the structure is a billboard support structure.

28. The apparatus of claim 18 wherein the structure is a support pole.

29. The apparatus of claim 28 wherein the support pole is a single electrical light fixture.

30. The apparatus of claim 28 wherein the support pole is a double electrical light fixture.

31. The apparatus of claim 18 wherein the structure is a support structure.

32. The apparatus of claim 31 wherein the support structure is a water tank.

33. The apparatus of claim 31 wherein the support structure is a directional billboard which aids vehicular traffic.

34. The apparatus of claim 18 wherein the structure is a light standard.
